(19) United States
(12) Patent Application Publication
(10) Pub. No.: US 2023/0246229 A1
(43) Pub. Date: Aug. 3, 2023

(54) ORGANIC SULFONATE ELECTROLYTE ADDITIVES FOR ZINC BATTERIES

(71) Applicant: Octet Scientific, Inc., Cleveland, OH (US)

(72) Inventors: Onas James BOLTON, Pepper Pike, OH (US); Emily Janine DICKENS, Cleveland, OH (US); Mark Richard RUBINO, Holland, MI (US)

(21) Appl. No.: 18/157,700

(22) Filed: Jan. 20, 2023

Related U.S. Application Data
(60) Provisional application No. 63/301,779, filed on Jan. 21, 2022.

(51) Int. Cl. H01M 10/0563

(52) U.S. Cl. CPC H01M 10/0563; H01M 2300/0005

(57) ABSTRACT

Provided herein are novel organic sulfonic acid or sulfonate zinc-battery electrolyte additive chemicals with surprising advantageous properties such as, but not limited to, stability and the ability to facilitate zinc plating while limiting the formation of zinc dendrites.

### CROSS-REFERENCE TO RELATED APPLICATIONS

This application claims priority to, and the benefit of, U.S. Ser. No. 63/301,779 filed Jan. 21, 2022, the entirety of which is hereby incorporated by reference for all purposes.

### STATEMENT OF GOVERNMENT RIGHTS

This invention was made with government support under SBIR 2013880 and SBIR 2136220 awarded by the National Science Foundation. The government has certain rights in this invention.

### FIELD

The present disclosure concerns organic sulfonate and sulfonic acid electrolyte additives for zinc-based rechargeable batteries, such as, but not limited to, zinc, zinc-lithium, zinc-carbon, zinc-chloride, zinc-bromide, zinc-air, zinc-iron, zinc-manganese dioxide, zinc-iodide, zinc-nickel, zinc-silver oxide, and other related zinc-anode-including batteries.

### BACKGROUND

Dendrite growth on zinc anodes is a major cause of failure and poor performance for zinc-batteries. One method of controlling and mitigating, if not preventing dendrite formation, includes using battery electrolyte additive chemicals. See, e.g., US Patent Publication No. 2020/0243909, which published Jul. 30, 2020, and is titled ZINC BATTERY ELECTROLYTE ADDITIVE, the entire contents of which are herein incorporated by reference in its entirety for all purposes.

What is needed are novel compositions and methods that control and prevent dendrite formation in zinc-batteries.

### SUMMARY

Provided herein are novel zinc-battery organic sulfonate and sulfonic acid electrolyte additive chemicals. It has been surprisingly discovered that the sulfonate and sulfonic acid electrolyte additives described herein provide for advantageous zinc plating and dendrite prevention.

In certain embodiments, the certain additives described herein also exhibit stability, for example, against oxidation by bromine.

When about 0.005 weight percent (wt %) to about 50 wt % of the electrolyte, relative to the total mass of the electrolyte, and about 0.1 wt % to about 35 wt % in particular, includes the novel zinc-battery sulfonic acid or sulfonate electrolyte additive chemicals set forth herein, the zinc-battery demonstrates unexpectedly improved performance during charging, discharging, and storage.

Provided herein are electrolyte compositions comprising a sulfonate or sulfonic acid electrolyte additive of Formula A, or a salt, zwitterion, cation, or anion thereof:

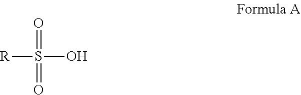

wherein:
R is L-R¹, L-Y⁺, C₃-C₈cycloalkyl, C₃-C₈heteroarylalkyl, or C₃-C₈heterocycloalkyl;
L is a linear C₁-C₆alkylene, branched C₁-C₆alkylene, C₃-C₈cycloalkylene, or C₃-C₈heterocycloalkylene;
wherein L is optionally substituted with one to four —OH; R¹ is selected from —OH, C₁₋₄alkoxy, —C(O)OR², —NR²C(O)R³, —NR^{4a}R^{4b}, C₁-C₆alkyl, hydroxyC₁-C₄alkyl, halogen, —S(O)R⁵, —S(O)₂R⁵, C₃-C₈cycloalkyl, and C₃-C₈heterocycloalkyl;
R² and R³ are independently selected from hydrogen, C₁-C₆alkyl, C₂-C₆alkenyl, aryl, heteroaryl, and arylC₁-C₄alkyl; wherein R² and R³ with the exception of hydrogen are independently optionally substituted with R⁶;
R^{4a} and R^{4b} are independently selected from hydrogen, C₁-C₆alkyl, hydroxyC₁-C₄alkyl, —CR⁷R⁸R⁹, —CH₂C(O)R¹⁰, cycloalkyl, aryl, heteroaryl, and arylC₁-C₄alkyl;
or R^{4a} and R^{4b} are taken together with the nitrogen to which they are attached to form a 6-membered heterocycloalkyl or heteroaryl optionally substituted with one to four R⁶;
R⁵ is —OH, C₁₋₄alkyl, aryl, or heteroaryl;
R⁶, when present, is independently in each instance selected from C₁-C₆alkyl, —NH₂, halogen, —OH, hydroxyC₁-C₄alkyl, and —C(O)OR¹¹;
R⁷, R⁸, and R⁹ are independently selected from hydrogen, C₁-C₆alkyl, aryl, arylC₁-C₄alkyl, cycloalkyl, —CH₂C(O)R¹⁰, and hydroxyC₁-C₄alkyl;
R¹⁰ is selected from —NH₂, —OH, and C₁-C₄alkyl;
R¹¹ is selected from hydrogen and C₁-C₄alkyl;
Y⁺ is selected from —N⁺R¹²R¹³R¹⁴, C₃-C₈heteroaryl containing at least one quaternary nitrogen, and C₃-C₈heterocycloalkyl containing at least one quaternary nitrogen; and
R¹², R¹³, and R¹⁴ are independently selected from hydrogen, C₁-C₆alkyl, aryl, arylC₁-C₄alkyl, cycloalkyl, hydroxyC₁-C₄alkyl, and —CR⁷R⁸R⁹;
or R¹² and R¹³ are taken together with the nitrogen to which they are attached to form a 6-membered heterocycloalkyl optionally substituted with one to four R⁶;

wherein the electrolyte additive is present in the electrolyte at a concentration equal to, or greater than, 0.005 weight percent (wt %) to less than, or equal to, 50 wt %.

In a preferred embodiment, the electrolyte additive is present in the electrolyte at a concentration between about 0.1 wt % to 35 wt %. In one embodiment, the electrolyte additive is present at a concentration between about 0.1 wt % and 10 wt %, between about 0.5 wt % and 5 wt %, or, between about 1 wt % and 2 wt %. In one embodiment, the electrolyte additive is present at a concentration of about 1 wt %. In one embodiment, the electrolyte additive is present at a concentration of about 2 wt %. In one embodiment, the electrolyte additive is present at a concentration of about 3 wt %. In one embodiment, the electrolyte additive is present at a concentration of about 4 wt %. In one embodiment, the electrolyte additive is present at a concentration of about 5 wt %.

In a preferred embodiment, the electrolyte composition is aqueous.

In one embodiment, the electrolyte composition comprises an electrolyte additive of Formula I, Formula II, or Formula III:

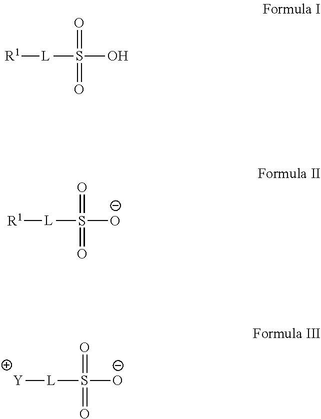

wherein R¹, Y⁺, and L are as defined herein; and wherein when the composition comprises a compound of Formula II, the composition further optionally comprises one or more cations selected from the group consisting of Na⁺, K⁺, Ca²⁺, Zn²⁺, and a quaternary ammonium cation with a net positive charge of one.

In an alternative embodiment, the electrolyte composition comprises an electrolyte additive of Formula IV:

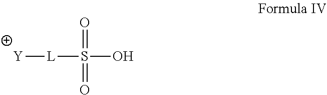

wherein the electrolyte composition optionally further comprises one or more anions selected from Cl⁻, Br⁻, I⁻, ClO₄⁻, C₂HO₄⁻, HSO₄⁻, HCO₂⁻, ClCH₂CO₂⁻, Cl₃CCO₂⁻, HOCH₂CO₂⁻, CF₃CO₂⁻, H₂PO₄⁻, CH₃SO₃⁻, PhSO₃⁻, p-CH₃-Ph-SO₃⁻,

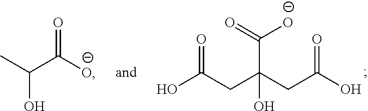

and

Y⁺ and L are as defined herein.

The molecules disclosed herein exist in dynamic equilibrium with protonated and de-protonated analogs, in which the equilibrium constant is temperature dependent. For example, certain molecules have labile hydrogen ions (i.e., protons) and will exist in a thermodynamic equilibrium; the labile protons will associate and dissociate from the molecule. In basic electrolytes and certain acidic electrolytes, such as those often used with zinc batteries, the aforementioned battery additives may be present in the electrolyte in a deprotonated form. For example, under these conditions, when R¹ is —S(O)₂R⁵, R⁵ in Formula II can exist as —O— and not —OH to afford an additive of Formula IIa:

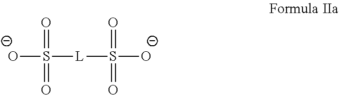

wherein Formula IIa optionally further comprises two cations selected from Na⁺, K⁺, and a quaternary ammonium cation with a net positive charge of one or one cation selected from Zn²⁺ and Ca²⁺.

Optionally substituted substituents (e.g., R², R³, R⁵, and R⁶) are unsubstituted unless explicitly stated otherwise.

In the embodiments described herein, the bond represented by

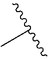

is the point of attachment to the rest of the compound.

In another example, set forth herein is a process for making a zinc battery, comprising contacting an electrolyte having a sulfonate or sulfonic acid electrolyte additive described herein with a zinc-battery electrode.

In another example, set forth herein is a method of using a zinc battery, comprising electrochemically cycling a zinc-battery comprising an electrolyte having a sulfonate or sulfonic acid electrolyte additive set forth herein.

Also described herein is a compound of the formula:

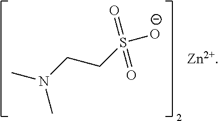

### BRIEF DESCRIPTION OF FIGURES

FIG. 1A is an image of zinc electrodeposited from a solution containing 1% wt methanesulfonic acid (MSA) as described in Example 1.

FIG. 1B is an image of zinc electrodeposited from a solution containing 1% wt of sodium isethionate as described in Example 1. Compared to FIG. 1A, zinc metal is deposited with thinner edge dendrites.

FIG. 2A is an image of zinc electrodeposited from a solution containing no additive (control) as described in Example 4.

FIG. 2B is an image of zinc electrodeposited from a solution containing 1% wt of 3-(benzyldimethylammonio)propanesulfonate as described in Example 4. Compared to FIG. 2A, zinc metal is deposited with shorter dendrites.

FIG. 2C is an image of zinc electrodeposited from a solution containing 1% wt of 2-(dimethylamino)ethanesulfonic acid as described in Example 4. Compared to FIG. 2A, zinc metal is deposited with shorter dendrites.

### DETAILED DESCRIPTION

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the disclosure herein is not intended to be limited to the embodiments presented, but are to be accorded their widest scope consistent with the principles and novel features disclosed herein.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Please note, if used, the labels left, right, front, back, top, bottom, forward, reverse, clockwise and counterclockwise have been used for convenience purposes only and are not intended to imply any particular fixed direction. Instead, they are used to reflect relative locations and/or directions between various portions of an object.

### I. DEFINITIONS

As used herein, the singular forms “a,” “an” and “the” include plural referents unless the context clearly dictates otherwise.

As used herein, the term “about,” when qualifying a number, e.g., 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, zinc may be referred to by its IUPAC chemical symbol, Zn.

As used herein, “alkyl” refers to a monovalent and saturated hydrocarbon radical moiety. Alkyl is optionally substituted and can be linear, branched, or cyclic, i.e., cycloalkyl. Alkyl includes, but is not limited to, those having 1-10 carbon atoms, i.e., C₁₋₁₀ alkyl; Examples of alkyl moieties include, but are not limited to methyl, ethyl, n-propyl, i-propyl, n-butyl, s-butyl, t-butyl, i-butyl, a pentyl moiety, a hexyl moiety, cyclopropyl, cyclobutyl, cyclopentyl, and cyclohexyl. In one embodiment, alkyl is linear. In one embodiment, alkyl is branched.

As used herein, “alkenyl” refers to a monovalent unsaturated hydrocarbon group, in certain embodiments, having from two to six carbon atoms, which can be linear or branched, and has at least one site of olefinic unsaturation. Alkenyl can be optionally substituted.

As used herein, “alkylene” refers to a divalent moiety of an alkyl compound. Alkylene may have from 1 to 6 carbon atoms, e.g., C₁alkylene, C₂alkylene, C₃alkylene, C₄alkylene, C₅alkylene, or C₆alkylene. Examples of alkylene moieties include, but are not limited to methylene, ethylene, propylene, butylene, pentylene, and hexylene.

As used herein, “cycloalkylene” refers to a divalent moiety of a cycloalkyl compound as described herein.

As used herein, “heterocycloalkylene” refers to a divalent moiety of an heterocycloalkyl compound as described herein.

As used herein, “alkoxy” refers to the group —OR‘ wherein R’ is alkyl. Alkoxy groups include, but are not limited to, methoxy, ethoxy, n-propoxy, isopropoxy, n-butoxy, tert-butoxy, and sec-butoxy.

As used herein, “aryl” refers to a monovalent moiety that is a radical of an aromatic compound wherein the ring atoms are carbon atoms. Aryl is optionally substituted and can be monocyclic or polycyclic, e.g., bicyclic or tricyclic. Examples of aryl moieties include, but are not limited to, those having 6 to 20 ring carbon atoms, i.e., C₆₋₂₀ aryl; 6 to 15 ring carbon atoms, i.e., C₆₋₁₅ aryl, and 6 to 10 ring carbon atoms, i.e., C₆₋₁₀ aryl. Examples of aryl moieties include, but are limited to, phenyl, naphthyl, fluorenyl, azulenyl, anthryl, phenanthryl, and pyrenyl.

As used herein, “cycloalkyl” refers to a monovalent, saturated monocyclic hydrocarbon. In some embodiments, the cycloalkyl group includes three to six carbon atoms, i.e., C₃-C₆cycloalkyl. Non-limiting examples of cycloalkyl include cyclopropyl, cyclobutyl, cyclopentyl, and cyclohexyl.

As used herein, “heteroaryl” refers to a monovalent moiety that is a radical of an aromatic compound wherein the ring atoms contain carbon atoms and at least one oxygen, sulfur, nitrogen, or phosphorus atom. Examples of heteroaryl moieties include, but are not limited to, those having 5 to 20 ring atoms; 5 to 15 ring atoms; and 5 to 10 ring atoms. Heteroaryl is optionally substituted unless explicitly stated otherwise. In certain embodiments, the heteroaryl contains 0, 1, or 2 nitrogen atoms and when 1 or 2 nitrogen atoms are present, at least 1 of the nitrogen atoms can be a quaternary nitrogen.

As used herein, “arylC₁-C₄alkyl” refers to an C₁₋₄alkyl group, as used herein, substituted with an aryl group, as defined herein. “Bn” or “benzyl” refers to “CH₂-phenyl.”

As used herein, “heterocycloalkyl” or “heterocycle” refers to a cycloalkyl in which one or more carbon atoms are replaced by heteroatoms. Suitable heteroatoms include, but are not limited to, nitrogen, oxygen, and sulfur atoms. Heterocycloalkyl is optionally substituted. Examples of heterocycloalkyl moieties include, but are not limited to, morpholinyl, piperidinyl, tetrahydropyranyl, pyrrolidinyl, imidazolidinyl, oxazolidinyl, thiazolidinyl, dioxolanyl, dithiolanyl, oxanyl, or thianyl. In certain embodiments, the heterocycloalkyl or heterocycle contains 0, 1, or 2 nitrogen atoms and when 1 or 2 nitrogen atoms are present, at least 1 of the nitrogen atoms can be a quaternary nitrogen.

As used herein, “hydroxyC₁-C₄alkyl” is an C₁₋₄alkyl group, as used herein, substituted with at least one hydroxyl group.

As used herein, “halogen” and “halo” refer to chloro, bromo, iodo, or fluoro.

As used herein, “optionally substituted,” when used to describe a radical moiety, e.g., optionally substituted alkyl, means that such moiety is optionally bonded to one or more substituents. Examples of such substituents include, but are not limited to halo, cyano, nitro, haloalkyl, azido, epoxy, optionally substituted heteroaryl, optionally substituted heterocycloalkyl

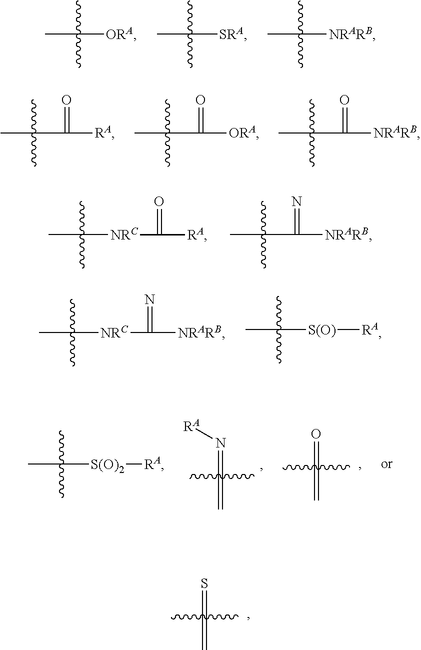

wherein R^{A}, R^{B}, and R^{C} are, independently at each occurrence, a hydrogen atom, alkyl, alkenyl, alkynyl, aryl, alkaryl, aralkyl, heteroalkyl, heteroaryl, or heterocycloalkyl, or R^{A} and R^{B}, together with the atoms to which they are bonded, form a saturated or unsaturated carbocyclic ring, wherein the ring is optionally substituted and wherein one or more ring atoms is optionally replaced with a heteroatom. In certain embodiments, when a radical moiety is optionally substituted with an optionally substituted heteroaryl, optionally substituted heterocycloalkyl, or optionally substituted saturated or unsaturated carbocyclic ring, the substituents on the optionally substituted heteroaryl, optionally substituted heterocycloalkyl, or optionally substituted saturated or unsaturated carbocyclic ring, if they are substituted, are not substituted with substituents which are further optionally substituted with additional substituents. In some embodiments, when a group described herein (e.g., R², R³, R⁵, and R⁶) is optionally substituted, the substituent bonded to the group is unsubstituted unless otherwise specified.

### II. ELECTROLYTES

Set forth herein are new electrolytes and organic sulfonate and sulfonic acid electrolyte additives. These sulfonate and sulfonic acid electrolyte additives are useful as electrolytes in zinc batteries. Zinc batteries includes zinc-air batteries as well as other types of zinc batteries. In some examples the electrolytes contemplated herein are neutral (with respect to pH). In some other examples the electrolytes contemplated herein are acidic (with respect to pH). One example of an acidic electrolyte is a zinc-bromine electrolyte. In certain embodiments, the pH of the electrolyte is acidic with a pH of less than about 7, for example a pH of less than about 6, less than about 5, less than about 4, less than about 3, less than about 2, or less than about 1. In one embodiment, the pH is about equal to or less than 3.

In yet other examples the electrolytes contemplated herein are basic (with respect to pH). One example of a basic electrolyte is a zinc-air battery. In addition, the electrolytes set forth herein may be used in zinc-manganese oxide batteries. The electrolytes set forth herein may be used in nickel-zinc batteries. Furthermore, the electrolytes set forth herein may be used in silver-zinc batteries or zinc-lithium batteries.

In one embodiment, the electrolyte composition comprises an electrolyte additive of Formula I, Formula II, or Formula III:

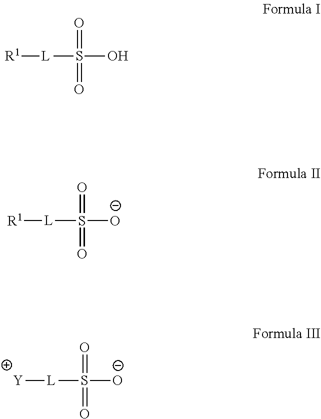

wherein R¹, Y⁺, and L are as defined herein; and wherein when the composition comprises a compound of Formula II, the composition further optionally comprises one or more cations selected from the group consisting of Na⁺, K⁺, Ca²⁺, Zn²⁺, and a quaternary ammonium cation with a net positive charge of one.

In an alternative embodiment, the electrolyte composition comprises an electrolyte additive of Formula IV:

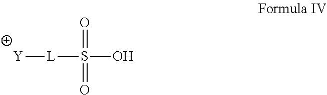

wherein Y⁺ and L are as defined herein; and wherein the electrolyte composition optionally further comprises one or more anions selected from Cl⁻, Br⁻, I⁻, ClO₄⁻, C₂HO₄⁻, HSO₄⁻, HCO₂⁻, ClCH₂CO₂⁻, Cl₃CCO₂⁻, HOCH₂CO₂⁻, CF₃CO₂⁻, H₂PO₄⁻, CH₃SO₃⁻, PhSO₃⁻, p- CH₃-Ph-SO₃⁻,

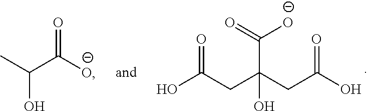

In an alternative embodiment, the composition comprises an electrolyte additive of Formula V:

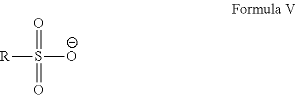

wherein R is C₃-C₈cycloalkyl, C₃-C₈heteroarylalkyl, or C₃-C₈heterocycloalkyl; and wherein the composition further optionally comprises one or more cations selected from the group consisting of Na⁺, K⁺, Ca²⁺, Zn²⁺, and a quaternary ammonium cation with a net positive charge of one.

In one embodiment, the electrolyte additive has the structure of Formula I, Formula II, or Formula III:

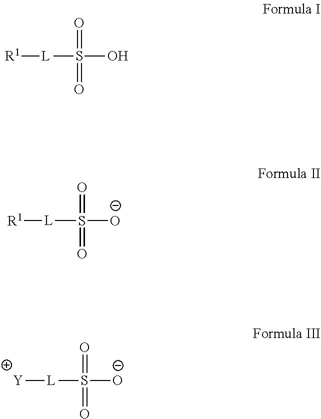

wherein:
L is a linear C₁-C₆alkylene, branched C₁-C₆alkylene, C₃-C₈cycloalkylene, or C₃-C₈heterocycloalkylene;
wherein L is optionally substituted with one to four —OH;
R¹ is selected from —OH, C₁₋₄alkoxy, —C(O)OR², —NR²C(O)R³, —NR^{4a}R^{4b}, C₁-C₆alkyl, hydroxyC₁-C₄alkyl, halogen, —S(O)R⁵, and —S(O)₂R⁵;
R² and R³ are independently selected from hydrogen, C₁-C₆alkyl, aryl, heteroaryl, and arylC₁-C₄alkyl; wherein R² and R³ with the exception of hydrogen are independently optionally substituted with R⁶;
R^{4a} and R^{4b} are independently selected from hydrogen, C₁-C₆alkyl, hydroxyC₁-C₄alkyl, —CR⁷R⁸R⁹, —CH₂C(O)R¹⁰, cycloalkyl, aryl, heteroaryl, and arylC₁-C₄alkyl;
or R^{4a} and R^{4b} are taken together with the nitrogen to which they are attached to form a 6-membered heterocycloalkyl or heteroaryl optionally substituted with one to four R⁶;
R⁵ is —OH, C₁₋₄alkyl, aryl, or heteroaryl;
R⁶, when present, is independently in each instance selected from C₁-C₆alkyl, —NH₂, halogen, —OH, hydroxyC₁-C₄alkyl, and —C(O)OR¹¹;
R⁷, R⁸, and R⁹ are independently selected from hydrogen, C₁-C₆alkyl, aryl, arylC₁-C₄alkyl, cycloalkyl, —CH₂C(O)R¹⁰, and hydroxyC₁-C₄alkyl;
R¹⁰ is selected from —NH₂, —OH, and C₁-C₄alkyl;
R¹¹ is selected from hydrogen and C₁-C₄alkyl;
Y⁺ is selected from —N⁺R¹²R¹³R¹⁴, C₃-C₈heteroaryl containing at least one quaternary nitrogen, and C₃-C₈heterocycloalkyl containing at least one quaternary nitrogen; and
R¹², R¹³, and R¹⁴ are independently selected from hydrogen, C₁-C₆alkyl, aryl, arylC₁-C₄alkyl, cycloalkyl, hydroxyC₁-C₄alkyl, and —CR⁷R⁸R⁹;
or R¹² and R¹³ are taken together with the nitrogen to which they are attached to form a 6-membered heterocycloalkyl optionally substituted with one to four R⁶;

wherein Formula II further optionally comprises a cation selected from the group consisting of Na⁺, K⁺, and a quaternary ammonium cation with a net positive charge of one; and

wherein the electrolyte additive is present in an electrolyte at a concentration equal to, or greater than, 0.005 weight percent (wt %) to less than, or equal to, 50 wt %.

In one embodiment, the electrolyte additive has the structure of Formula I:

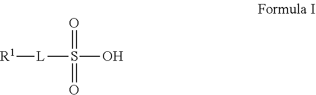

wherein:

L is C₁-C₆alkylene optionally substituted with 1 —OH group;

R¹ is selected from —OH, —C(O)OR², —NR^{4a}R^{4b}, C₁-C₆alkyl, and halogen;

R² and R³ are independently selected from hydrogen, C₁-C₆alkyl, and C₂₋₆alkenyl;

R^{4a} and R^{4b} are independently selected from hydrogen and C₁-C₆alkyl;

or R^{4a} and R^{4b} are taken together with the nitrogen to which they are attached to form a 6-membered heterocycloalkyl optionally substituted with one R⁶;

R⁶, when present, is —C(O)OR¹¹;

wherein the electrolyte additive is present in an electrolyte at a concentration equal to, or greater than, 0.01 weight percent (wt %) to less than, or equal to, 35 wt %.

In certain embodiments, the additive of Formula I is selected from:

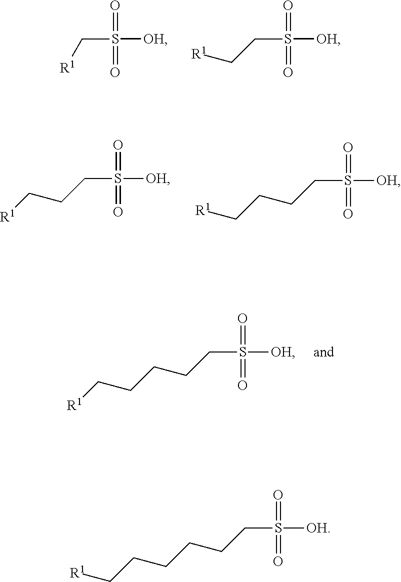

In certain embodiments, the additive of Formula I is selected from:

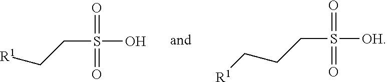

Formula I and certain chemical structures set forth herein are drawn as a neutrally charged molecules. However, molecules disclosed herein exist in dynamic equilibrium with protonated and de-protonated analogs, in which the equilibrium constant is temperature dependent. For example, certain molecules have labile hydrogen ions (i.e., protons) and will exist in a thermodynamic equilibrium; the labile protons will associate and dissociate from the molecule. In basic electrolytes and certain acidic electrolytes, such as those often used with zinc batteries, the aforementioned battery additives may be present in the electrolyte in a deprotonated form. For example, the following electrolyte additives having a deprotonated sulfonic acid group may be present in place of, or in addition to, the conjugate bases illustrated above. In a preferred embodiment, the electrolyte additive is present in acidic electrolyte (a pH of about 3) and the electrolyte additive exists in the deprotonated sulfonic acid form.

For example, in certain embodiments, the additive of Formula I is selected from a compound of Formula II:

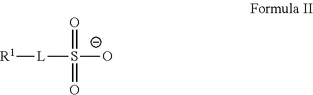

and optionally further comprises a cation or cations selected from the group consisting of Na⁺, K⁺, and a quaternary ammonium cation with a net positive charge of one.

In certain embodiments, the additive of Formula I is selected from a compound of Formula II:

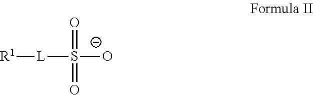

and optionally further comprises a cation selected from the group consisting of Na⁺, K⁺, and a quaternary ammonium cation with a net positive charge of one.

In one embodiment, the additive of Formula II is a compound of the formula:

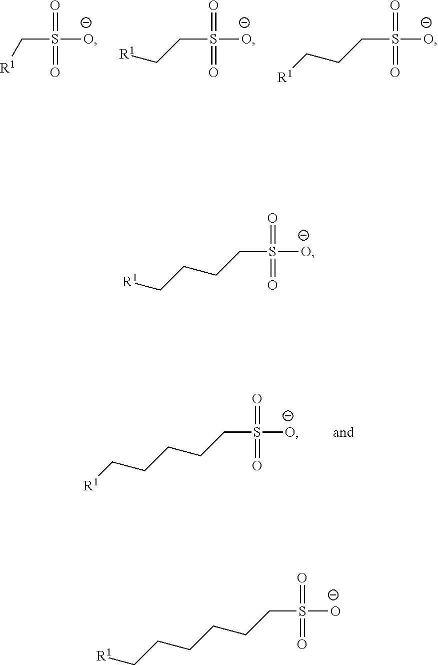

and optionally further comprises a cation selected from Na⁺, K⁺, and a quaternary ammonium cation with a net positive charge of one.

As discussed above, the molecules disclosed herein exist in dynamic equilibrium with protonated and de-protonated analogs, in which the equilibrium constant is temperature dependent. For example, certain electrolyte additives can have two deprotonated sulfonic acid groups that may be present in place of, or in addition to, the conjugate bases illustrated above.

For example, in certain embodiments, the additive of Formula II is an additive of Formula IIa:

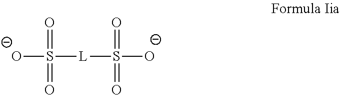

and optionally further comprises two cations selected from Na⁺, K⁺, and a quaternary ammonium cation with a net positive charge of one or one cation selected from Ca²⁺ and Zn²⁺.

In other embodiments, the additive of Formula II is an additive of Formula IIb or Formula IIc:

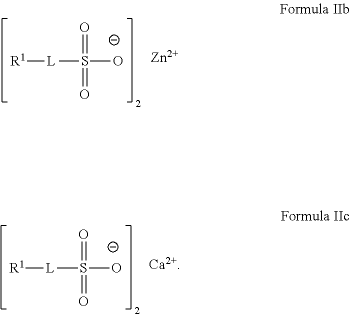

In one embodiment of Formula I, Formula II, Formula IIa, Formula IIb, or Formula IIc, L is selected from unsubstituted C₁alkylene, unsubstituted C₂alkylene, unsubstituted C₃alkylene, unsubstituted C₄alkylene, unsubstituted C₅alkylene, and unsubstituted C₆alkylene. In one embodiment of Formula I, Formula II, Formula IIa, Formula IIb, or Formula IIc, L unsubstituted C₂alkylene or unsubstituted C₃alkylene. In one embodiment of Formula I, Formula II, Formula IIa, Formula IIb, or Formula IIc, L is C₁alkylene, C₂alkylene, C₃alkylene, C₄alkylene, C₅alkylene, or C₆alkylene substituted with one —OH group. In one embodiment of Formula I, Formula II, Formula IIa, Formula IIb, or Formula IIc, L is C₂alkylene, C₃alkylene, C₄alkylene, C₅alkylene, or C₆alkylene substituted with two —OH groups. In one embodiment of Formula I, Formula II, Formula IIa, Formula IIb, or Formula IIc, L is C₃alkylene, C₄alkylene, C₅alkylene, or C₆alkylene substituted with three —OH groups.

In one embodiment of Formula I, Formula II, Formula IIa, Formula IIb, or Formula IIc, L is selected from

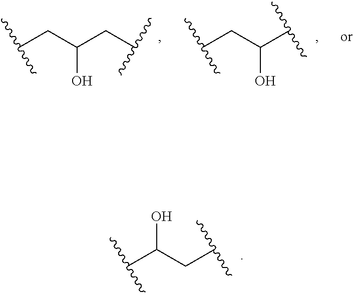 [SMILES: *CC(O)C* ; *CC(*)O ; *CC(*)O]

In one embodiment of Formula I, Formula II, Formula IIa, Formula IIb, or Formula IIc, L is C₃-C₈cycloalkylene. In one embodiment of Formula I, Formula II, Formula IIa, Formula IIb, or Formula IIc, L is C₃-C₈heterocycloalkylene.

In one embodiment of Formula I, Formula II, Formula IIb, or Formula IIc, including any of the foregoing, R¹ is —OH. In one embodiment of Formula I, Formula II, Formula IIb, or Formula IIc, including any of the foregoing, R¹ is —C(O)OR². In one embodiment of Formula I, Formula II, Formula IIb, or Formula IIc, including any of the foregoing, R¹ is —C(O)OH. In one embodiment of Formula I, Formula II, Formula IIb, or Formula IIc, including any of the foregoing, R¹ is —C(O)OC₁₋₆alkyl. In one embodiment of Formula I, Formula II, Formula IIb, or Formula IIc, including any of the foregoing, R¹ is —C(O)OCH₃. In one embodiment of Formula I, Formula II, Formula IIb, or Formula IIc, including any of the foregoing, R¹ is —C(O)OCH₂CH₃. In one embodiment of Formula I, Formula II, Formula IIb, or Formula IIc, including any of the foregoing, R¹ is —C(O)OCH₂CH₂CH₃. In one embodiment of Formula I, Formula II, Formula IIb, or Formula IIc, including any of the foregoing, R¹ is —C(O)OCH(CH₃)₂. In one embodiment of Formula I, Formula II, Formula IIb, or Formula IIc, including any of the foregoing, R¹ is —C(O)OCH₂CH₂CH₂CH₃. In one embodiment of Formula I, Formula II, Formula IIb, or Formula IIc, including any of the foregoing, R¹ is —C(O)OCH₂CH(CH₃)₂. In one embodiment of Formula I, Formula II, Formula IIb, or Formula IIc, including any of the foregoing, R¹ is —C(O)OC(CH₃)₃. In one embodiment of Formula I, Formula II, Formula IIb, or Formula IIc, including any of the foregoing, R¹ is —C(O)O-arylC₁-C₄alkyl. In one embodiment of Formula I, Formula II, Formula IIb, or Formula IIc, including any of the foregoing, R¹ is —C(O)OBn.

In one embodiment of Formula I, Formula II, Formula IIb, or Formula IIc, including any of the foregoing, R¹ is —NR^{4a}R^{4b}. In one embodiment of Formula I, Formula II, Formula IIb, or Formula IIc, including any of the foregoing, R¹ is —NR^{4a}R^{4b} and R^{4a} and R^{4b} are independently selected from hydrogen, methyl, ethyl, n-propyl, iso-propyl, n-butyl, iso-butyl, tert-butyl, and benzyl. In one embodiment of Formula I, Formula II, Formula IIb, or Formula IIc, including any of the foregoing, R¹ is —NH₂. In one embodiment of Formula I, Formula II, Formula IIb, or Formula IIc, including any of the foregoing, R¹ is —N(CH₃)₂. In one embodiment of Formula I, Formula II, Formula IIb, or Formula IIc, including any of the foregoing, R¹ is —N(CH₂CH₃)₂. In one embodiment of Formula I, Formula II, Formula IIb, or Formula IIc, including any of the foregoing, R¹ is —N(CH₂CH₂CH₃)₂. In one embodiment of Formula I, Formula II, Formula IIb, or Formula IIc, including any of the foregoing, R¹ is —N(CH₂(CH₃)₂)₂. In one embodiment of Formula I, Formula II, Formula IIb, or Formula IIc, including any of the foregoing, R¹ is —N(CH₂CH₂CH₂CH₃)₂. In one embodiment of Formula I, Formula II, Formula IIb, or Formula IIc, including any of the foregoing, R¹ is —N(CH₂CH(CH₃)₂)₂. In one embodiment of Formula I, Formula II, Formula IIb, or Formula IIc, including any of the foregoing, R¹ is —N(C(CH₃)₃)₂. In one embodiment of Formula I, Formula II, Formula IIb, or Formula IIc, including any of the foregoing, R¹ is —NHBn. In one embodiment of Formula I, Formula II, Formula IIb, or Formula IIc, including any of the foregoing, R¹ is —N(CH₃)Bn.

In one embodiment of Formula I, Formula II, Formula IIb, or Formula IIc, including any of the foregoing, R¹ is —NR^{4a}R^{4b} wherein R^{4a} is hydrogen and R^{4b} is alkyl. In one embodiment of Formula I, Formula II, Formula IIb, or Formula IIc, including any of the foregoing, R¹ is —NR^{4a}R^{4b} wherein R^{4a} is hydrogen and R^{4b} is methyl. In one embodiment of Formula I, Formula II, Formula IIb, or Formula IIc, including any of the foregoing, R¹ is —NR^{4a}R^{4b} wherein R^{4a} is hydrogen and R^{4b} is ethyl.

In one embodiment of Formula I, Formula II, Formula IIb, or Formula IIc, including any of the foregoing, R¹ is —NR^{4a}R^{4b} wherein R^{4a} is hydrogen and R^{4b} is cycloalkyl. In one embodiment of Formula I, Formula II, Formula IIb, or Formula IIc, including any of the foregoing, R¹ is —NR^{4a}R^{4b} wherein R^{4a} is hydrogen and R^{4b} is cyclohexyl.

In one embodiment of Formula I, Formula II, Formula IIb, or Formula IIc, including any of the foregoing, R¹ is —NR^{4a}R^{4b} wherein R^{4a} and R^{4b} are hydroxyC₁-C₄alkyl. In one embodiment of Formula I, Formula II, Formula IIb, or Formula IIc, including any of the foregoing, R¹ is —N(CH₂CH₂OH)₂.

In one embodiment of Formula I, Formula II, Formula IIb, or Formula IIc, including any of the foregoing, R¹ is —NR^{4a}R^{4b} wherein R^{4a} is hydrogen, R^{4b} is —CR⁷R⁸R⁹, and R⁷, R⁸, and R⁹ are independently selected from C₁-C₆alkyl and hydroxyC₁-C₄alkyl. In one embodiment of Formula I, Formula II, Formula IIb, or Formula IIc, including any of the foregoing, R¹ is selected from

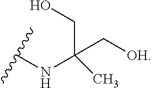 [SMILES: *NC(C)(CO)CO]

In one embodiment of Formula I, Formula II, Formula IIb, or Formula IIc, including any of the foregoing, R¹ is selected from

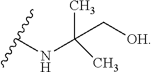 [SMILES: *NC(C)(C)CO]

In the embodiments described herein, the bond represented by

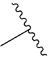

is the point of attachment to the rest of the compound.

In one embodiment of Formula I, Formula II, Formula IIb, or Formula IIc, including any of the foregoing, R¹ is —NR^{4a}R^{4b} wherein R^{4a} and R^{4b} are taken together with the nitrogen to which they are attached to form a 6-membered heterocycloalkyl. In one embodiment of Formula I, Formula II, Formula IIb, or Formula IIc, R¹ is

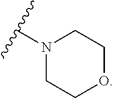 [SMILES: *N1CCOCC1]

In one embodiment of Formula I, Formula II, Formula IIb, or Formula IIc, R¹ is

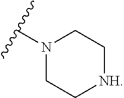 [SMILES: *N1CCNCC1]

In one embodiment of Formula I, Formula II, Formula IIb, or Formula IIc, including any of the foregoing, R¹ is —NR^{4a}R^{4b} wherein R^{4a} and R^{4b} are taken together with the nitrogen to which they are attached to form a 6-membered heterocycloalkyl optionally substituted with one to four R⁶. In one embodiment of Formula I, Formula II, Formula IIb, or Formula IIc, R¹ is

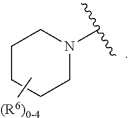

In one embodiment of Formula I, Formula II, Formula IIb, or Formula IIc, R¹ is

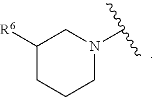

In one embodiment of Formula I, Formula II, Formula IIb, or Formula IIc, R¹ is

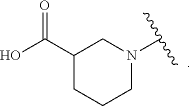 [SMILES: *N1CCCC(C(=O)O)C1]

In one embodiment of Formula I, Formula II, Formula IIb, or Formula IIc, including any of the foregoing, R¹ is —NR^{4a}R^{4b} wherein R^{4a} is hydrogen and R^{4b} is —CH₂C(O)R¹⁰. In one embodiment of Formula I, Formula II, Formula IIb, or Formula IIc, including any of the foregoing, R¹ is —NR^{4a}R^{4b} wherein R^{4a} is hydrogen and R^{4b} is —CH₂C(O)NH₂.

In one embodiment of Formula I, Formula II, Formula IIb, or Formula IIc, including any of the foregoing, R¹ is —NR²C(O)R³ wherein R² is hydrogen and R³ is C₁-C₆alkyl. In one embodiment of Formula I, Formula II, Formula IIb, or Formula IIc, including any of the foregoing, R¹ is —NR²C(O)R³ wherein R² is hydrogen and R³ is C₂-C₆alkenyl. In one embodiment of Formula I, Formula II, Formula IIb, or Formula IIc, R¹ is —NHC(O)CH₃. In one embodiment of Formula I, Formula II, Formula IIb, or Formula IIc, including any of the foregoing, R¹ is —NHC(O)CH₂═CH₃.

In one embodiment of Formula I, Formula II, Formula IIb, or Formula IIc, including any of the foregoing, R¹ is C₁-C₆alkyl. In one embodiment of Formula I, Formula II, Formula IIb, or Formula IIc, including any of the foregoing, L is C₂-C₅alkenylene and R¹ is —CH₃.

In one embodiment of Formula I, Formula II, Formula IIb, or Formula IIc, including any of the foregoing, R¹ is —S(O)₂R⁵ and R⁵ is C₁₋₄alkyl. In one embodiment of Formula I, Formula II, Formula IIb, or Formula IIc, including any of the foregoing, R¹ is —S(O)₂CH₃.

In one embodiment of Formula I, Formula II, Formula IIb, or Formula IIc, including any of the foregoing, R¹ is halogen. In one embodiment of Formula I, Formula II, Formula IIb, or Formula IIc, including any of the foregoing, R¹ is Br. In one embodiment of Formula I, Formula II, Formula IIb, or Formula IIc, including any of the foregoing, R¹ is C₁. In one embodiment of Formula I, Formula II, Formula IIb, or Formula IIc, including any of the foregoing, R¹ is I.

In certain embodiments, the additive of Formula I is selected from:

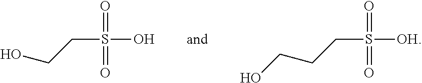 [SMILES: O=S(=O)(O)CCO ; O=S(=O)(O)CCCO]

In certain embodiments, the additive of Formula I is selected from:

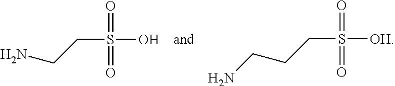 [SMILES: NCCS(=O)(=O)O ; NCCCS(=O)(=O)O]

In certain embodiments, the additive of Formula I is selected from:

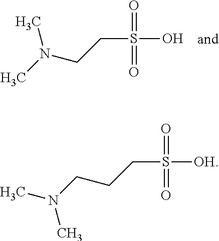

In certain embodiments, the additive of Formula I is selected from:

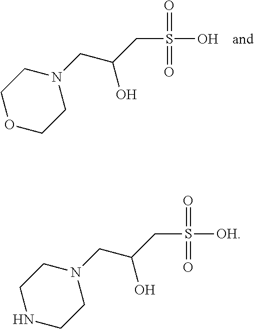 [SMILES: O=S(=O)(O)CC(O)CN1CCOCC1 ; O=S(=O)(O)CC(O)CN1CCNCC1]

In certain embodiments, the additive of Formula I is:

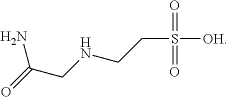 [SMILES: NC(=O)CNCCS(=O)(=O)O]

In certain embodiments, the additive of Formula I is selected from:

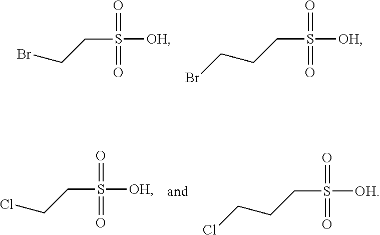 [SMILES: O=S(=O)(O)CCBr ; O=S(=O)(O)CCCBr ; O=S(=O)(O)CCCl ; O=S(=O)(O)CCCCl]

In certain embodiments, the additive of Formula I is:

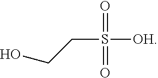

In certain embodiments, the additive of Formula I is:

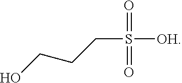

In certain embodiments, the additive of Formula I is:

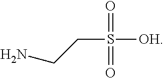

In certain embodiments, the additive of Formula I is:

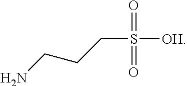

In certain embodiments, the additive of Formula I is:

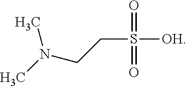

In certain embodiments, the additive of Formula I is:

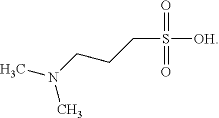

In certain embodiments, the additive of Formula I is:

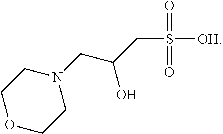 [SMILES: O=S(=O)(O)CC(O)CN1CCOCC1]

In certain embodiments, the additive of Formula I is:

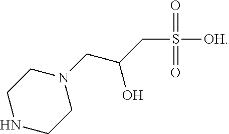 [SMILES: O=S(=O)(O)CC(O)CN1CCNCC1]

In certain embodiments, the additive of Formula I is:

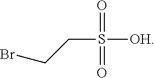

In certain embodiments, the additive of Formula I is:

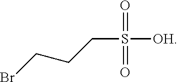

In certain embodiments, the additive of Formula I is:

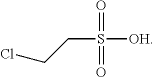

In certain embodiments, the additive of Formula I is:

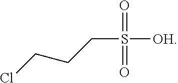

In alternative embodiments, the additive of Formula I is:

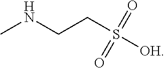

In alternative embodiments, the additive of Formula I is:

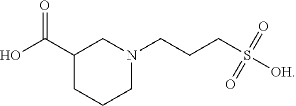 [SMILES: O=C(O)C1CCCN(CCCS(=O)(=O)O)C1]

In alternative embodiments, the additive of Formula I is:

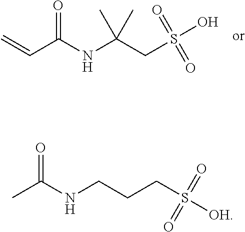

In alternative embodiments, the additive of Formula I is:

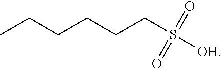

In alternative embodiments, the additive of Formula I is:

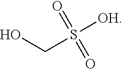

In certain embodiments, the additive of Formula II is selected from:

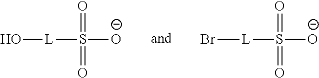

and optionally further comprises a cation selected from Na⁺, K⁺, and a quaternary ammonium cation with a net positive charge of one.

In certain embodiments, the additive of Formula II is:

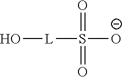

and optionally further comprises a cation selected from Na⁺, K⁺, and a quaternary ammonium cation with a net positive charge of one.

In certain embodiments, the additive of Formula II is:

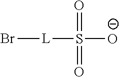

and optionally further comprises a cation selected from Na⁺, K⁺, and a quaternary ammonium cation with a net positive charge of one.

In certain embodiments, the additive of Formula II is selected from:

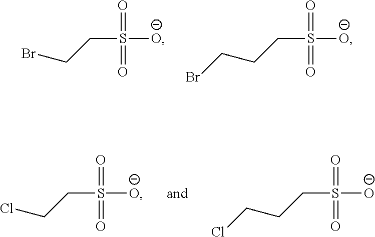

and optionally further comprises a cation selected from Na⁺, K⁺, and a quaternary ammonium cation with a net positive charge of one.

In certain embodiments, the additive of Formula II is selected from:

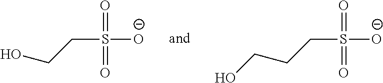 [SMILES: O=S(=O)([O-])CCO ; O=S(=O)([O-])CCCO]

and optionally further comprises a cation selected from Na⁺, K⁺, and a quaternary ammonium cation with a net positive charge of one.

In alternative embodiments, the additive of Formula II is:

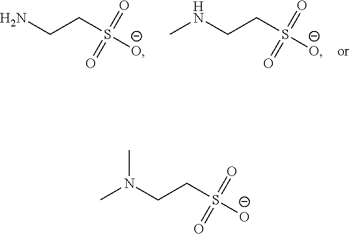

and optionally further comprises a cation selected from Na⁺, K⁺, and a quaternary ammonium cation with a net positive charge of one.

In alternative embodiments, the additive of Formula II is:

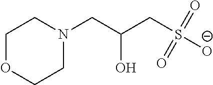 [SMILES: O=S(=O)([O-])CC(O)CN1CCOCC1]

and optionally further comprises a cation selected from Na⁺, K⁺, and a quaternary ammonium cation with a net positive charge of one.

In alternative embodiments, the additive of Formula II is:

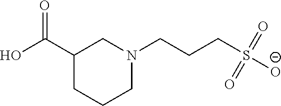 [SMILES: O=C(O)C1CCCN(CCCS(=O)(=O)[O-])C1]

and optionally further comprises a cation selected from Na⁺, K⁺, and a quaternary ammonium cation with a net positive charge of one.

In alternative embodiments, the additive of Formula II is:

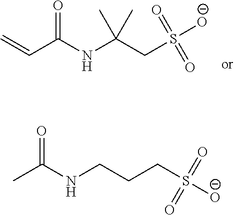

and optionally further comprises a cation selected from Na⁺, K⁺, and a quaternary ammonium cation with a net positive charge of one.

In alternative embodiments, the additive of Formula II is:

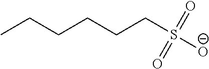

and optionally further comprises a cation selected from Na⁺, K⁺, and a quaternary ammonium cation with a net positive charge of one.

In alternative embodiments, the additive of Formula II is:

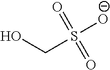

and optionally further comprises a cation selected from Na⁺, K⁺, and a quaternary ammonium cation with a net positive charge of one.

In certain embodiments, the additive of Formula II is selected from:

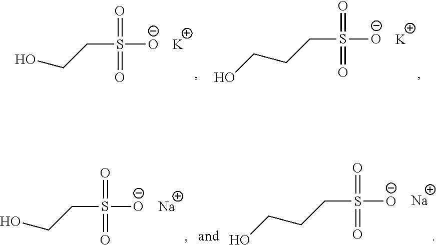

In certain embodiments, the additive of Formula II is selected from:

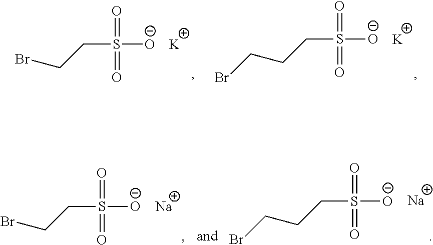

In alternative embodiments, the additive of Formula II is:

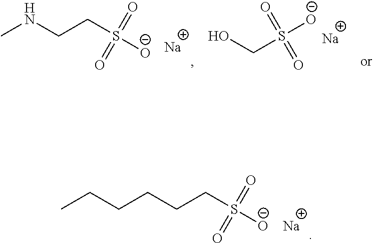

In one embodiment, the additive of Formula IIb is 2

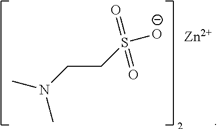

In one embodiment, the additive of Formula IIc is 2

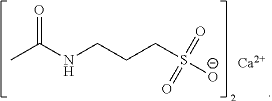

In certain embodiments, the quaternary ammonium cation with a net positive charge of one is of the formula

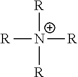

wherein R is selected from hydrogen and C₁-C₆alkyl, for example, but not limited to, methyl, ethyl, propyl, isopropyl, butyl, t-butyl, sec-butyl, isobutyl, —CH₂C(CH₃)₃, —CH(CH₂CH₃)₂, and —CH₂CH(CH₂CH₃)₂, cyclopropyl, CH₂-cyclopropyl, cyclobutyl, and CH₂-cyclobutyl. In one embodiment,

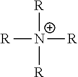

is a tetraalkylammonium compound, including, but not limited to tetramethylammonium. In one embodiment,

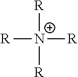

### is +NH₄.

In acidic electrolytes and lightly basic electrolytes, such as those often used with zinc batteries, the aforementioned battery additives substituted with an amine may be present in the electrolyte as a zwitterion wherein the sulfonic acid is deprotonated and the amine is protonated. In a preferred embodiment, the electrolyte additive is present in acidic electrolyte (a pH of about 3) and the electrolyte additive substituted with an amine exists as a zwitterion.

In some embodiments, including any of the foregoing, the electrolyte additive is selected from:

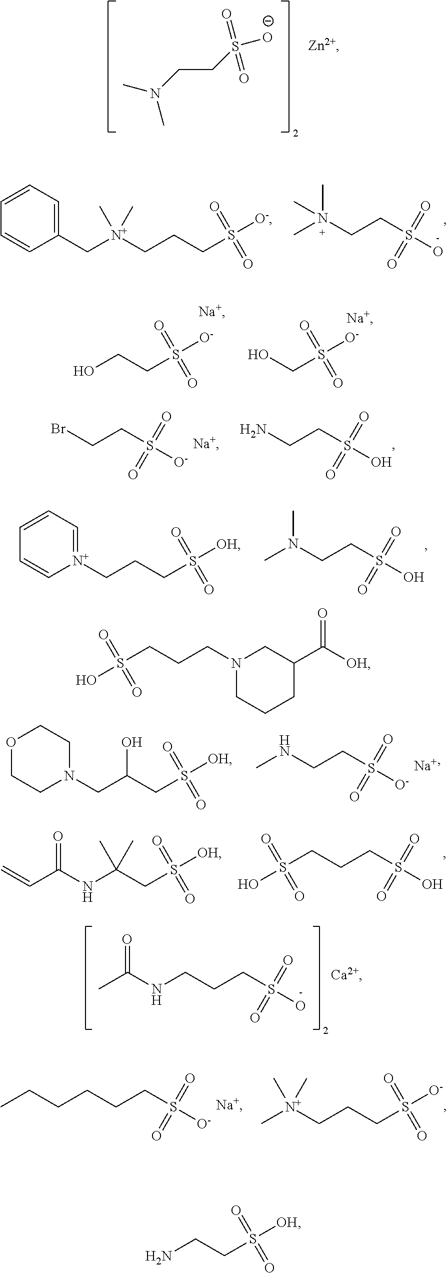

and combinations thereof

For example, the electrolyte additives described herein may be a zwitterion of Formula III:

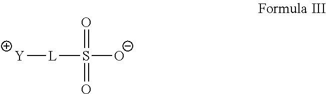

wherein:
L is C₁-C₆alkylene optionally substituted with 1 —OH group;
Y⁺ is selected from —N⁺R¹²R¹³R¹⁴ and C₃-C₈heteroaryl containing at least one quaternary nitrogen;
R⁶, when present is —C(O)OR¹¹;
R¹¹ is hydrogen; and
R¹², R¹³, and R¹⁴ are independently selected from hydrogen, C₁-C₆alkyl, and arylC₁-C₄alkyl;
or R¹² and R¹³ are taken together with the nitrogen to which they are attached to form a 6-membered heterocycloalkyl;
wherein the electrolyte additive is present in an electrolyte at a concentration equal to, or greater than, 0.01 weight percent (wt %) to less than, or equal to, 35 wt %.

Alternatively, in highly acidic electrolytes, an additive substituted with a protonated amine may be present as the protonated sulfonic acid form. Non-limiting examples of strong acids that may comprise the electrolyte include HCl, HBr, perchloric acid, oxalic acid, sulfuric acid, formic acid, chloroacetic acid, trichloroacetic acid, glycolic acid, oxalic acid, trifluoroacetic acid, phosphoric acid, methanesulfonic acid, benzenesulfonic acid, toluenesulfonic acid, lactic acid, and citric acid.

For example, the electrolyte additives described herein may be a compound of Formula IV:

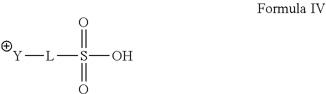

wherein:
L is C₁-C₆alkylene optionally substituted with 1 —OH group;
Y⁺ is selected from —N⁺R¹²R¹³R¹⁴ and C₃-C₈heteroaryl containing at least one quaternary nitrogen;
R⁶, when present is —C(O)OR¹¹;
R¹¹ is hydrogen; and
R¹², R¹³, and R¹⁴ are independently selected from hydrogen, C₁-C₆alkyl, and arylC₁-C₄alkyl;
or R¹² and R¹³ are taken together with the nitrogen to which they are attached to form a 6-membered heterocycloalkyl;

wherein the additive of Formula IV optionally further comprises an anion selected from Cl⁻, Br⁻, I⁻, ClO₄⁻, C₂HO₄⁻, HSO₄⁻, HCO₂⁻, ClCH₂CO₂⁻, Cl₃CCO₂⁻, HOCH₂CO₂⁻, C₂O₄²⁻, CF₃CO₂⁻, H₂PO₄⁻, CH₃SO₃⁻, PhSO₃⁻, p-CH₃-Ph-SO₃⁻, OH, and OH;

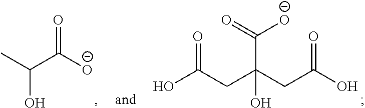

and
wherein the electrolyte additive is present in an electrolyte at a concentration equal to, or greater than, 0.01 weight percent (wt %) to less than, or equal to, 35 wt %.

In one embodiment of Formula III or Formula IV, L is selected from unsubstituted C₁alkylene, unsubstituted C₂alkylene, unsubstituted C₃alkylene, unsubstituted C₄alkylene, unsubstituted C₅alkylene, and unsubstituted C₆alkylene. In one embodiment of Formula III or Formula IV, L unsubstituted C₂alkylene or unsubstituted C₃alkylene. In one embodiment of Formula III or Formula IV, L is C₁alkylene, C₂alkylene, C₃alkylene, C₄alkylene, C₅alkylene, or C₆alkylene substituted with one —OH group. In one embodiment of Formula III or Formula IV, L is C₂alkylene, C₃alkylene, C₄alkylene, C₅alkylene, or C₆alkylene substituted with two —OH groups. In one embodiment of Formula III or Formula IV, L is C₃alkylene, C₄alkylene, C₅alkylene, or C₆alkylene substituted with three —OH groups.

In one embodiment of Formula III or Formula IV, L is selected from

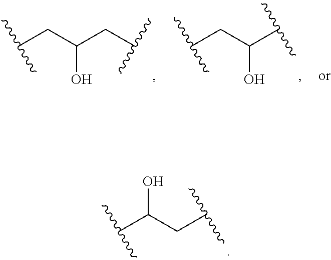 [SMILES: *CC(O)C* ; *CC(*)O ; *CC(*)O]

In one embodiment of Formula III or Formula IV, L is C₃-C₈cycloalkylene. In one embodiment of Formula III or Formula IV, L is C₃-C₈heterocycloalkylene.

In certain embodiments, the additive of Formula III is selected from:

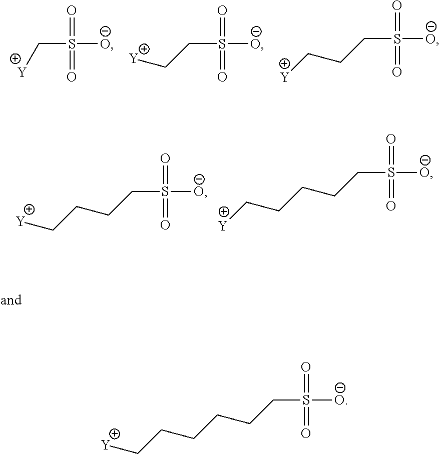

In certain embodiments, the additive of Formula IV is selected from:

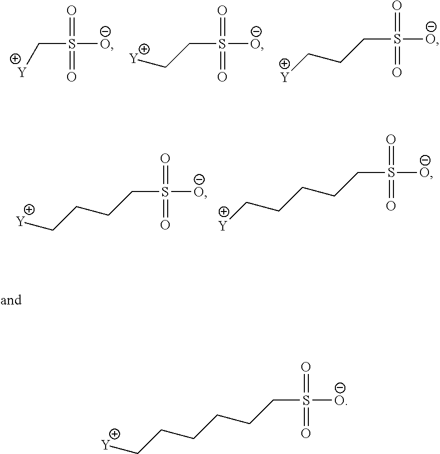

In one embodiment of Formula III or Formula IV, including any of the foregoing, Y⁺ is —N⁺R¹²R¹³R¹⁴. In one embodiment of Formula III or Formula IV, including any of the foregoing, Y⁺ is —N⁺R¹²R¹³R¹⁴ wherein R¹², R¹³, and R¹⁴ are independently selected from hydrogen, C₁-C₆alkyl and arylC₁-C₄alkyl. In one embodiment of Formula III or Formula IV, including any of the foregoing, Y⁺ is —N⁺H₃. In one embodiment of Formula III or Formula IV, including any of the foregoing, R¹² and R¹³ are C₁-C₆alkyl and R¹⁴ is arylC₁-C₄alkyl. In one embodiment of Formula III or Formula IV, including any of the foregoing, Y⁺ is

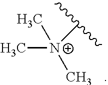 [SMILES: *[N+](C)(C)C]

In one embodiment of Formula III or Formula IV, including any of the foregoing, Y⁺ is

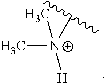 [SMILES: *[NH+](C)C]

In one embodiment of Formula III or Formula IV, including any of the foregoing, Y⁺ is

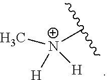 [SMILES: *[NH2+]C]

In one embodiment of Formula III or Formula IV, including any of the foregoing, Y⁺ is

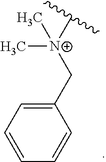 [SMILES: *[N+](C)(C)Cc1ccccc1]

In one embodiment of Formula III or Formula IV, including any of the foregoing, Y⁺ is —N⁺R¹²R¹³R¹⁴ wherein R¹², R¹³, and R¹⁴ are independently selected from hydrogen, methyl, ethyl, n-propyl, iso-propyl, n-butyl, iso-butyl, tert-butyl, and benzyl.

In one embodiment of Formula III or Formula IV, including any of the foregoing, Y⁺ is —N⁺R¹²R¹³R¹⁴ wherein R¹² and R¹³ are hydrogen and R¹⁴ is cycloalkyl. In one embodiment of Formula III or Formula IV, including any of the foregoing, Y⁺ is —N⁺R¹²R¹³R¹⁴ wherein R¹² and R¹³ are hydrogen and R¹⁴ is cyclohexyl.

In one embodiment of Formula III or Formula IV, Y⁺ is

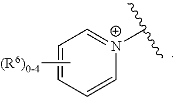

In one embodiment of Formula III or Formula IV, Y⁺ is

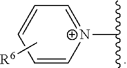

In one embodiment of Formula III or Formula IV, Y⁺ is

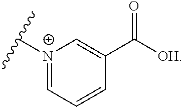 [SMILES: *[n+]1cccc(C(=O)O)c1]

In one embodiment of Formula III or Formula IV, Y⁺ is

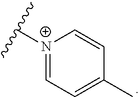 [SMILES: *[n+]1ccc(C)cc1]

In one embodiment of Formula III or Formula IV, Y⁺ is

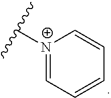 [SMILES: *[n+]1ccccc1]

In one embodiment of Formula III or Formula IV, including any of the foregoing, Y⁺ is —N⁺R¹²R¹³R¹⁴ wherein R¹² and R¹³ are taken together with the nitrogen to which they are attached to form a 6-membered heterocycloalkyl. In one embodiment of Formula III or Formula IV, including any of the foregoing, Y⁺ is

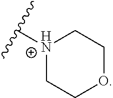

In one embodiment of Formula III or Formula IV, including any of the foregoing, Y⁺ is

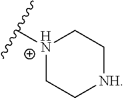

In one embodiment of Formula III or Formula IV, including any of the foregoing, Y⁺ is —N⁺R¹²R¹³R¹⁴ wherein R¹², R¹³, and R¹⁴ are hydroxyC₁-C₄alkyl. In one embodiment of Formula III or Formula IV, including any of the foregoing, Y⁺ is —N⁺H(CH₂CH₂OH)₂.

In one embodiment of Formula III or Formula IV, including any of the foregoing, Y⁺ is —N⁺R¹²R¹³R¹⁴ wherein R¹² and R¹³ are hydrogen R¹⁴ is —CR⁷R⁸R⁹, and R⁷, R⁸, and R⁹ are independently selected from C₁-C₆alkyl and hydroxyC₁-C₄alkyl. In one embodiment of Formula III or Formula IV, including any of the foregoing, Y⁺ is selected from

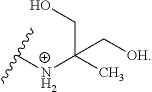 [SMILES: *[NH2+]C(C)(CO)CO]

In one embodiment of Formula III or Formula IV, including any of the foregoing, Y⁺ is selected from

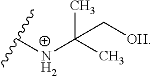 [SMILES: *[NH2+]C(C)(C)CO]

In one embodiment of Formula III or Formula IV, including any of the foregoing, Y⁺ is —N⁺R¹²R¹³R¹⁴ wherein R¹² and R¹³ are hydrogen and R¹⁴ is —CH₂C(O)R¹⁰. In one embodiment of Formula III or Formula IV, including any of the foregoing, Y⁺ is —N⁺R¹²R¹³R¹⁴ wherein R¹² and R¹³ are hydrogen and R¹⁴ is —CH₂C(O)NH₂.

In certain embodiments, the additive of Formula III is selected from:

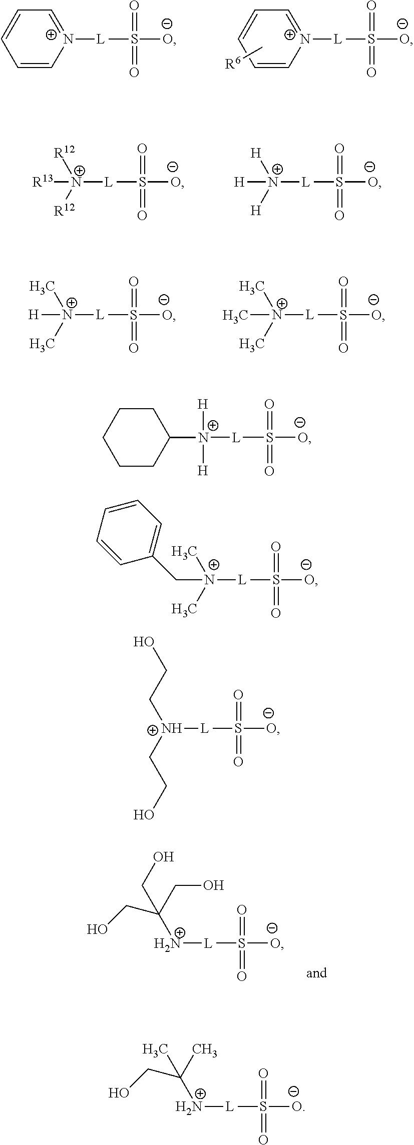

In alternative embodiments, the additive of Formula III is

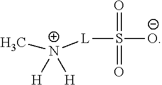

In certain embodiments, the additive of Formula III is selected from:

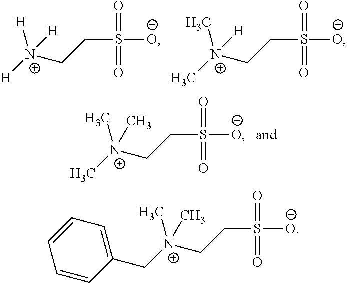

In certain embodiments, the additive of Formula III is selected from:

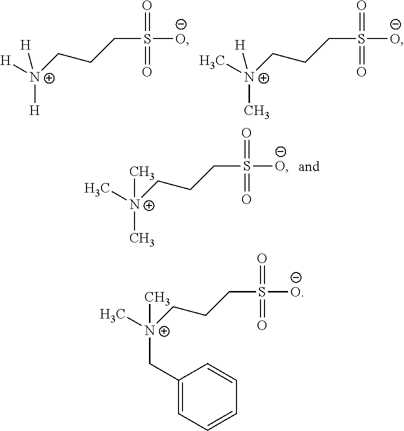

In certain embodiments, the additive of Formula III is selected from:

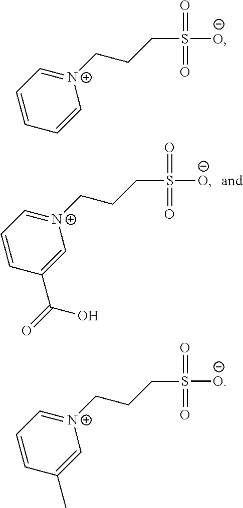

In certain embodiments, the additive of Formula III is selected from:

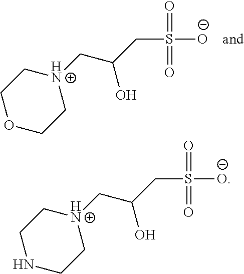

In certain embodiments, the additive of Formula III is:

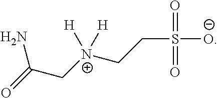

In alternative embodiments, the additive of Formula III is

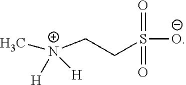

In certain embodiments, the additive of Formula III is selected from:

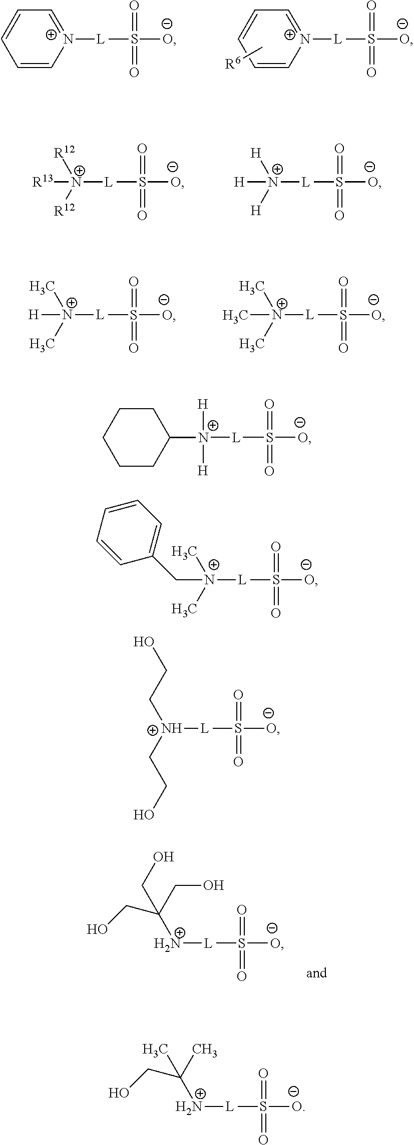

In alternative embodiments, the additive of Formula III is

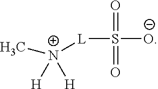

In certain embodiments, the additive of Formula IV is selected from:

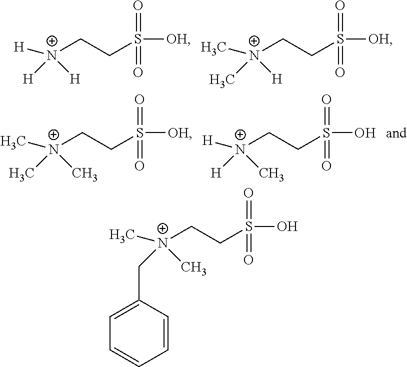

and optionally further comprises an anion selected from Cl⁻, Br⁻, I⁻, ClO₄⁻, C₂HO₄⁻, HSO₄⁻, HCO₂⁻, ClCH₂CO₂⁻, Cl₃CCO₂⁻, HOCH₂CO₂⁻, C₂O₄²⁻, CF₃CO₂⁻, H₂PO₄⁻, CH₃SO₃⁻, PhSO₃⁻, p-CH₃-Ph-SO₃⁻,

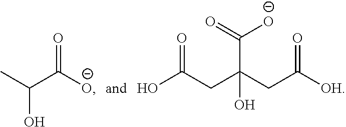

In certain embodiments, the additive of Formula IV is selected from:

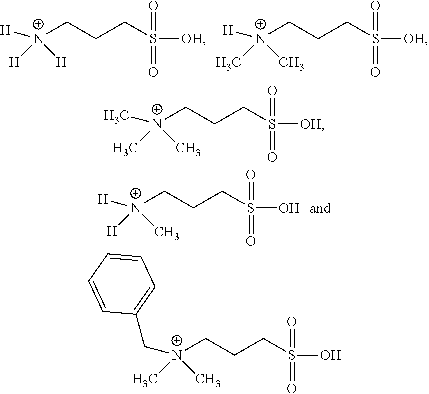

and optionally further comprises an anion selected from Cl⁻, Br⁻, I⁻, ClO₄⁻, C₂HO₄⁻, HSO₄⁻, HCO₂⁻, ClCH₂CO₂⁻, Cl₃CCO₂⁻, HOCH₂CO₂⁻, C₂O₄²⁻, CF₃CO₂⁻, H₂PO₄⁻, CH₃SO₃⁻, PhSO₃⁻, p-CH₃-Ph-SO₃⁻,

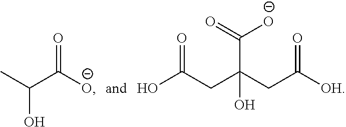

In certain embodiments, the additive of Formula III is selected from:

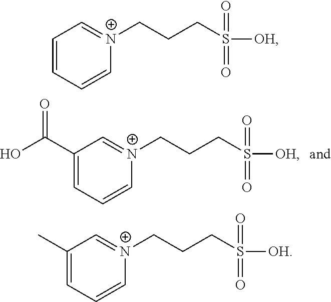 [SMILES: O=S(=O)(O)CCC[n+]1ccccc1 ; O=C(O)c1ccc[n+](CCCS(=O)(=O)O)c1 ; Cc1ccc[n+](CCCS(=O)(=O)O)c1]

In certain embodiments, the additive of Formula IV is selected from:

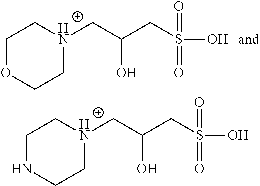

and optionally further comprises an anion selected from Cl⁻, Br⁻, I⁻, ClO₄⁻, C₂HO₄⁻, HSO₄⁻, HCO₂⁻, ClCH₂CO₂⁻, ClC₃CCO₂⁻, HOCH₂CO₂⁻, C₂O₄²⁻, CF₃CO₂⁻, H₂PO₄⁻, CH₃SO₃⁻, PhSO₃⁻, p-CH₃-Ph-SO₃⁻,

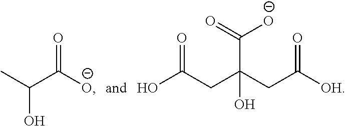

In certain embodiments, the additive of Formula IV is:

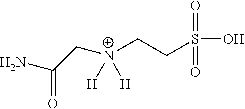 [SMILES: NC(=O)C[NH2+]CCS(=O)(=O)O]

and optionally further comprises an anion selected from Cl⁻, Br⁻, I⁻, ClO₄⁻, C₂HO₄⁻, HSO₄⁻, HCO₂⁻, ClCH₂CO₂⁻, ClC₃CCO₂⁻, HOCH₂CO₂⁻, C₂O₄²⁻, CF₃CO₂⁻, H₂PO₄⁻, CH₃SO₃⁻, PhSO₃⁻, p-CH₃-Ph-SO₃⁻,

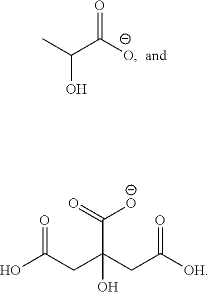

Also described herein are additives of Formula V:

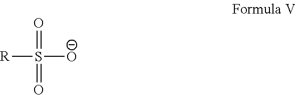

wherein R is C₃-C₈cycloalkyl, C₃-C₈heteroarylalkyl, or C₃-C₈heterocycloalkyl; and wherein the additive of Formula V optionally comprises one cation selected from the group consisting of Na⁺, K⁺, Ca²⁺, Zn²⁺, and a quaternary ammonium cation with a net positive charge of one.

In one embodiment of Formula A or Formula V, R is C₃-C₈cycloalkyl. In one embodiment of Formula A or Formula V, R is C₃-C₈heterocycloalkyl. In one embodiment of Formula A or Formula V, R is C₃-C₈heteroarylalkyl. In one embodiment of Formula A or Formula V, R is cyclopropyl, cyclobutyl, cyclopentyl, cyclohexyl, cycloheptyl, or cyclooctyl. In one embodiment of Formula A or Formula V, the C₃-C₈heterocycloalkyl contains at least one nitrogen substituted with R¹⁵ wherein R¹⁵ is hydrogen, C₁-C₆alkyl, cycloalkyl, aryl, heteroaryl, or arylC₁-C₄alkyl. In certain embodiment of Formula A or Formula V, the C₃-C₈heterocycloalkyl contains at least one nitrogen substituted with R¹⁵ and the nitrogen is a quaternary nitrogen. In one embodiment of Formula A or Formula V, R is selected from

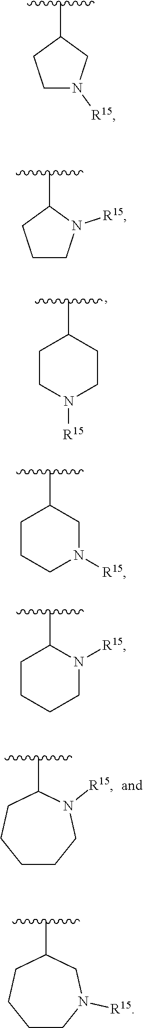

In one embodiment of Formula A or Formula V, R is

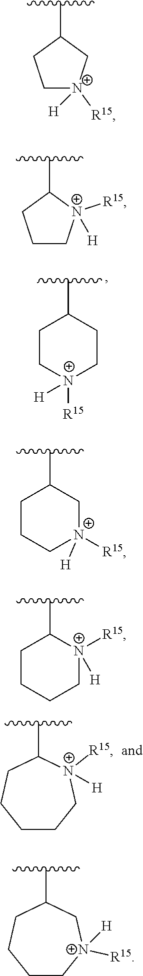

In one embodiment of Formula A or Formula V, R is selected from

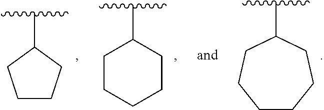

In one embodiment of Formula A or Formula V, R is selected from

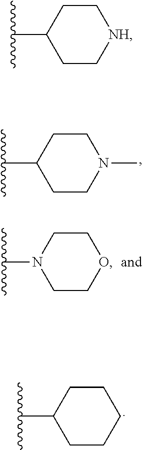

In one embodiment of Formula A or Formula V, R is C₃-C₈heteroarylalkyl wherein the heteroaryl of the heteroarylalkyl contains at least one nitrogen substituted with R¹⁵ wherein R¹⁵ is hydrogen, C₁-C₆alkyl, cycloalkyl, aryl, heteroaryl, or arylC₁-C₄alkyl. In certain embodiment of Formula A or Formula V, the C₃-C₈heteroarylalkyl contains at least one nitrogen substituted with R¹⁵ and the nitrogen is a quaternary nitrogen.

In the embodiments described herein, the bond represented by

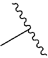

is the point of attachment to the rest of the compound.

In one embodiment, the compound of Formula A is selected from:

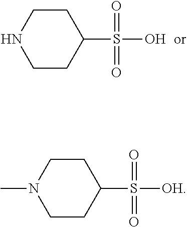

In one embodiment, the compound of Formula A is selected from:

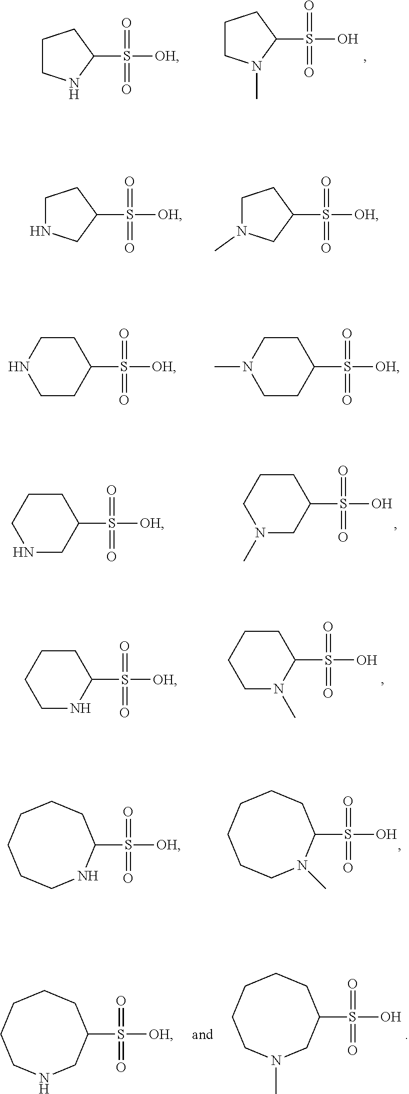

In one embodiment, the compound of Formula A is selected from:

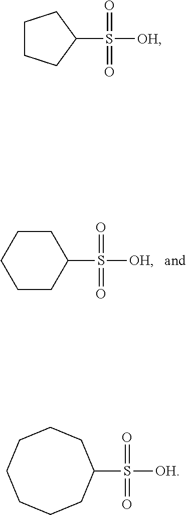 [SMILES: O=S(=O)(O)C1CCCC1 ; O=S(=O)(O)C1CCCCC1 ; O=S(=O)(O)C1CCCCCCC1]

In one embodiment, the compound of Formula V is selected from:

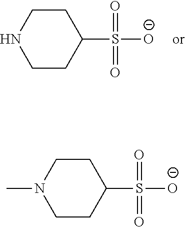

and optionally further comprises a cation selected from Na⁺, K⁺, and a quaternary ammonium cation with a net positive charge of one.

In one embodiment, the compound of Formula IV is selected from:

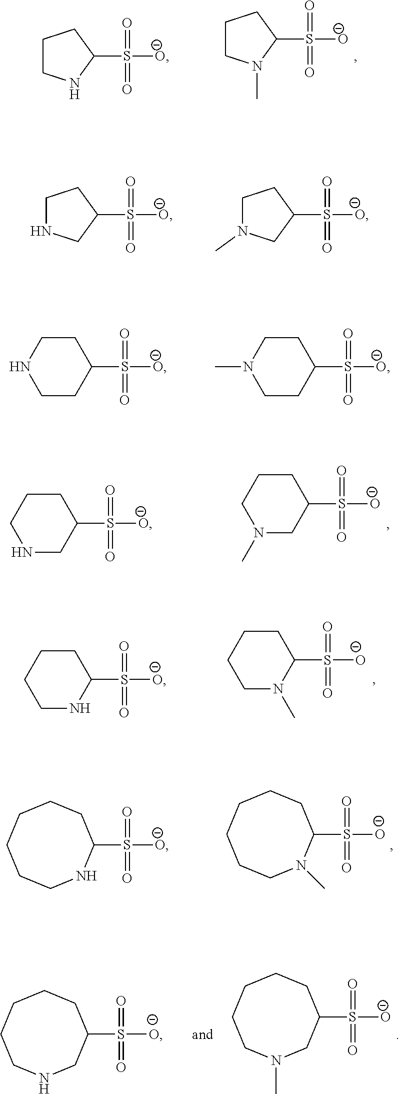

and optionally further comprises a cation selected from Na⁺, K⁺, and a quaternary ammonium cation with a net positive charge of one.

In one embodiment, the compound of Formula A is selected from:

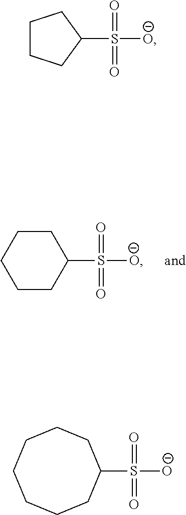

and optionally further comprises a cation selected from Na⁺, K⁺, and a quaternary ammonium cation with a net positive charge of one.

In certain embodiments, the additive is selected from:

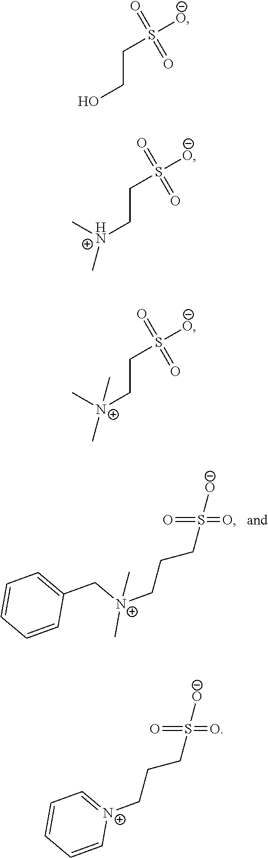

In certain embodiments, the additive is selected from:

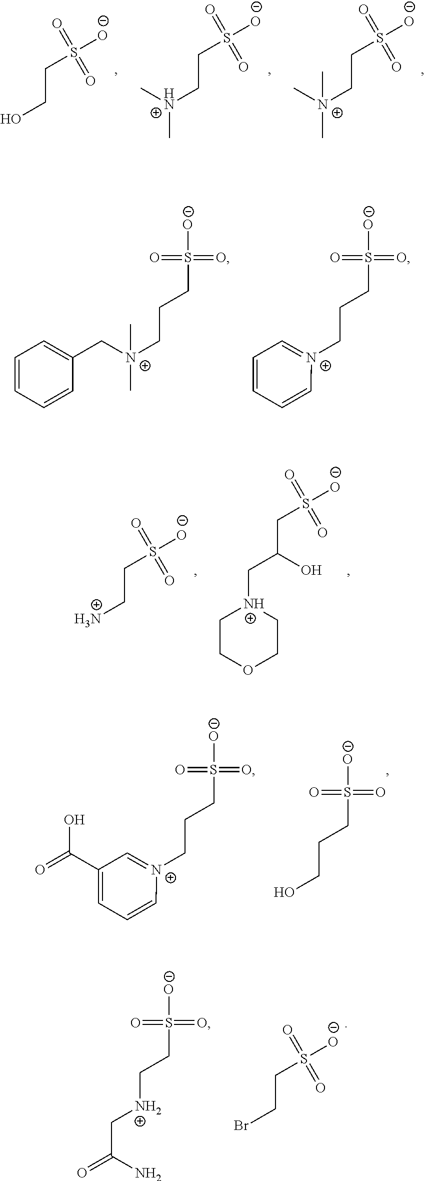

In certain embodiments, the additive is selected from:

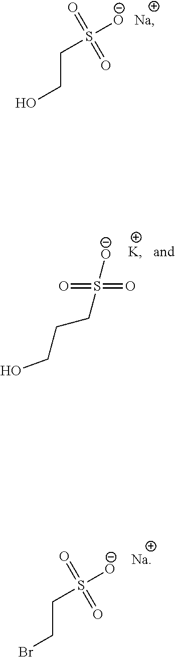

In certain embodiments, the additive is selected from:

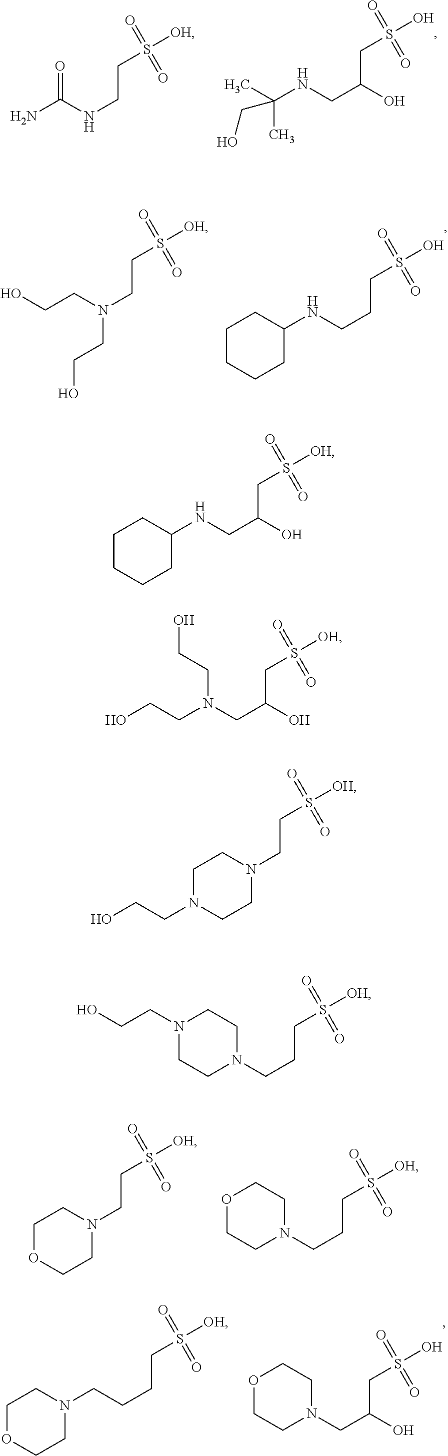

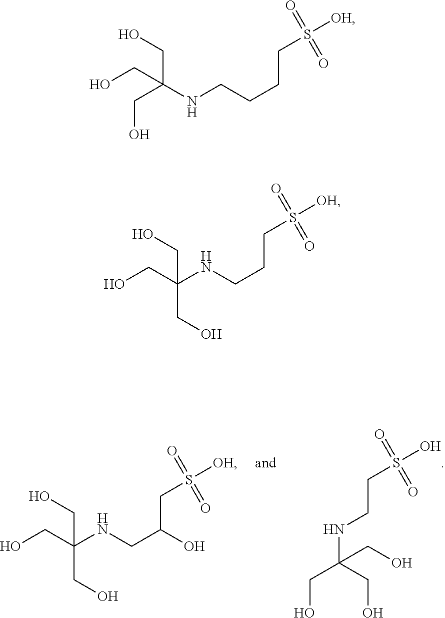 [SMILES: O=S(=O)(O)CCCCNC(CO)(CO)CO ; O=S(=O)(O)CCCNC(CO)(CO)CO ; O=S(=O)(O)CC(O)CNC(CO)(CO)CO ; O=S(=O)(O)CCNC(CO)(CO)CO]

In certain embodiments, the additive is selected from:

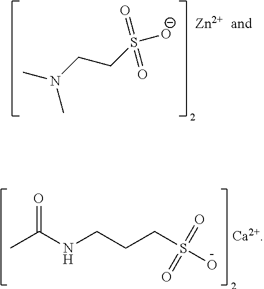

Non-limiting examples of sulfonic acid and sulfonate electrolyte additives described herein include:

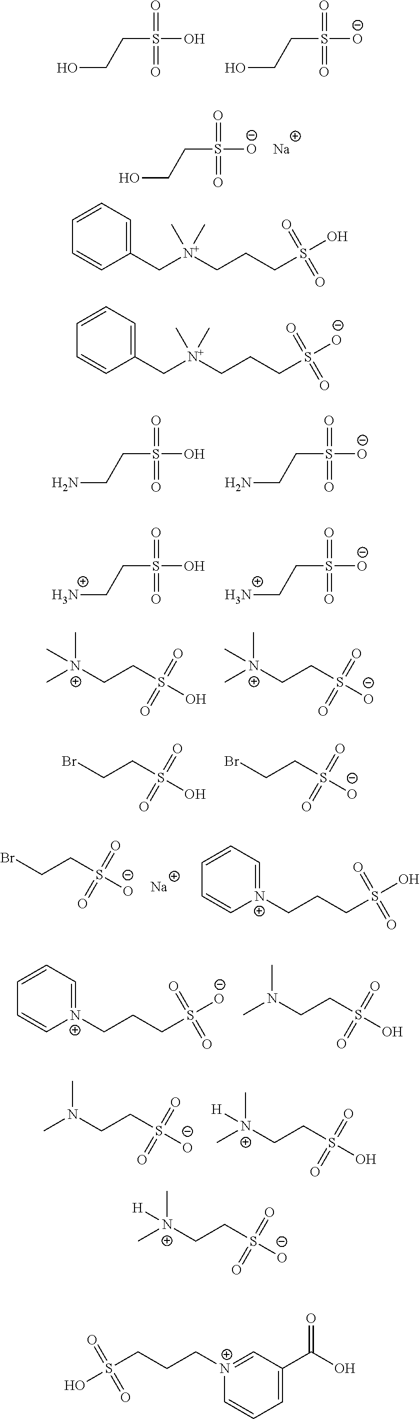

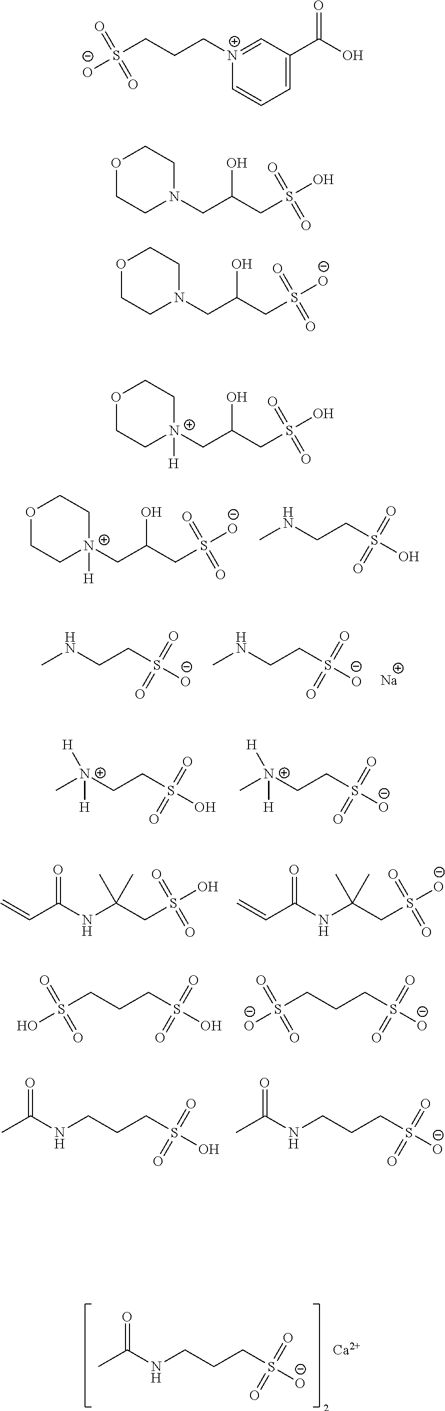

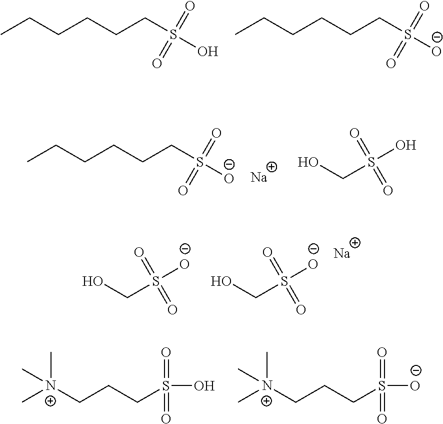

wherein the compounds further optionally comprise a cation selected from the group consisting of Na⁺, K⁺, Ca²⁺, Zn²⁺, a quaternary ammonium cation with a net positive charge of one, or a combination thereof.

In some examples, including any of the foregoing, the sulfonic acid or sulfonate electrolyte additive is present in an electrolyte at a concentration equal to, or greater than, 0.01 weight percent (wt %) to less than, or equal to, 50 wt %.

In some examples, including any of the foregoing, the sulfonic acid or sulfonate electrolyte additive is present in an electrolyte at a concentration equal to, or greater than, 0.05 weight percent (wt %) to less than, or equal to, 50 wt %.

In some examples, including any of the foregoing, the sulfonic acid or sulfonate electrolyte additive is present in an electrolyte at a concentration equal to, or greater than, 0.1 weight percent (wt %) to less than, or equal to, 50 wt %.

In some examples, including any of the foregoing, the sulfonic acid or sulfonate electrolyte additive is present in an electrolyte at a concentration equal to, or greater than, 0.5 weight percent (wt %) to less than, or equal to, 50 wt %.

In some examples, including any of the foregoing, the sulfonic acid or sulfonate electrolyte additive is present in an electrolyte at a concentration equal to, or greater than, 1 weight percent (wt %) to less than, or equal to, 50 wt %.

In some examples, including any of the foregoing, the sulfonic acid or sulfonate electrolyte additive is present in an electrolyte at a concentration equal to, or greater than, 5 weight percent (wt %) to less than, or equal to, 50 wt %.

In some examples, including any of the foregoing, the sulfonic acid or sulfonate electrolyte additive is present in an electrolyte at a concentration equal to, or greater than, 10 weight percent (wt %) to less than, or equal to, 50 wt %.

In some examples, including any of the foregoing, the sulfonic acid or sulfonate electrolyte additive is present in an electrolyte at a concentration equal to, or greater than, 15 weight percent (wt %) to less than, or equal to, 50 wt %.

In some examples, including any of the foregoing, the sulfonic acid or sulfonate electrolyte additive is present in an electrolyte at a concentration equal to, or greater than, 20 weight percent (wt %) to less than, or equal to, 50 wt %.

In some examples, including any of the foregoing, the sulfonic acid or sulfonate electrolyte additive is present in an electrolyte at a concentration equal to, or greater than, 30 weight percent (wt %) to less than, or equal to, 50 wt %.

In some examples, including any of the foregoing, the sulfonic acid or sulfonate electrolyte additive is present in an electrolyte at a concentration equal to, or greater than, 40 weight percent (wt %) to less than, or equal to, 50 wt %.

In some examples, including any of the foregoing, the sulfonic acid or sulfonate electrolyte additive is present in an electrolyte at a concentration equal to, or greater than, 0.01 weight percent (wt %) to less than, or equal to, 40 wt %.

In some examples, including any of the foregoing, the sulfonic acid or sulfonate electrolyte additive is present in an electrolyte at a concentration equal to, or greater than, 0.01 weight percent (wt %) to less than, or equal to, 30 wt %.

In some examples, including any of the foregoing, the sulfonic acid or sulfonate electrolyte additive is present in an electrolyte at a concentration equal to, or greater than, 0.01 weight percent (wt %) to less than, or equal to, 20 wt %.

In some examples, including any of the foregoing, the sulfonic acid or sulfonate electrolyte additive is present in an electrolyte at a concentration equal to, or greater than, 0.01 weight percent (wt %) to less than, or equal to, 15 wt %.

In some examples, including any of the foregoing, the sulfonic acid or sulfonate electrolyte additive is present in an electrolyte at a concentration equal to, or greater than, 0.01 weight percent (wt %) to less than, or equal to, 10 wt %.

In some examples, including any of the foregoing, the sulfonic acid or sulfonate electrolyte additive is present in an electrolyte at a concentration equal to, or greater than, 0.01 weight percent (wt %) to less than, or equal to, 5 wt %.

In some examples, including any of the foregoing, the sulfonic acid or sulfonate electrolyte additive is present in an electrolyte at a concentration equal to, or greater than, 0.01 weight percent (wt %) to less than, or equal to, 1 wt %.

In some examples, including any of the foregoing, the sulfonic acid or sulfonate electrolyte additive is present in an electrolyte at a concentration equal to, or greater than, 0.01 weight percent (wt %) to less than, or equal to, 0.5 wt %.

In some examples, including any of the foregoing, the sulfonic acid or sulfonate electrolyte additive is present in an electrolyte at a concentration equal to, or greater than, 0.01 weight percent (wt %) to less than, or equal to, 0.1 wt %.

In some examples, including any of the foregoing, the sulfonic acid or sulfonate electrolyte additive is present in an electrolyte at a concentration equal to, or greater than, 0.01 weight percent (wt %) to less than, or equal to, 0.05 wt %.

In other examples, including any of the foregoing, the sulfonic acid or sulfonate electrolyte additive is present in an electrolyte at a concentration equal to, or greater than, 0.1 weight percent (wt %) to less than, or equal to, 35 wt %.

In other examples, including any of the foregoing, the sulfonic acid or sulfonate electrolyte additive is present in an electrolyte at a concentration equal to, or greater than, 0.1 weight percent (wt %) to less than, or equal to, 25 wt %.

In other examples, including any of the foregoing, the sulfonic acid or sulfonate electrolyte additive is present in an electrolyte at a concentration equal to, or greater than, 0.1 weight percent (wt %) to less than, or equal to, 15 wt %.

In other examples, including any of the foregoing, the sulfonic acid or sulfonate electrolyte additive is present in an electrolyte at a concentration equal to, or greater than, 0.1 weight percent (wt %) to less than, or equal to, 10 wt %.

In other examples, including any of the foregoing, the sulfonic acid or sulfonate electrolyte additive is present in an electrolyte at a concentration equal to, or greater than, 0.5 weight percent (wt %) to less than, or equal to, 5 wt %.

In other examples, including any of the foregoing, the sulfonic acid or sulfonate electrolyte additive is present in an electrolyte at a concentration equal to, or greater than, 1 weight percent (wt %) to less than, or equal to, 2 wt %.

In some examples, including any of the foregoing, the sulfonic acid or sulfonate electrolyte additive is present in an electrolyte at a concentration of about 50 weight percent (wt 0%).

In some examples, including any of the foregoing, the sulfonic acid or sulfonate electrolyte additive is present in an electrolyte at a concentration of about 40 weight percent (wt 0%).

In some examples, including any of the foregoing, the sulfonic acid or sulfonate electrolyte additive is present in an electrolyte at a concentration of about 30 weight percent (wt 0%).

In some examples, including any of the foregoing, the sulfonic acid or sulfonate electrolyte additive is present in an electrolyte at a concentration of about 25 weight percent (wt %).

In some examples, including any of the foregoing, the sulfonic acid or sulfonate electrolyte additive is present in an electrolyte at a concentration of about 20 weight percent (wt %).

In some examples, including any of the foregoing, the sulfonic acid or sulfonate electrolyte additive is present in an electrolyte at a concentration of about 15 weight percent (wt %).

In some examples, including any of the foregoing, the sulfonic acid or sulfonate electrolyte additive is present in an electrolyte at a concentration of about 10 weight percent (wt %).

In some examples, including any of the foregoing, the sulfonic acid or sulfonate electrolyte additive is present in an electrolyte at a concentration of about 5 weight percent (wt %).

In some examples, including any of the foregoing, the sulfonic acid or sulfonate electrolyte additive is present in an electrolyte at a concentration of about 4 weight percent (wt %).

In some examples, including any of the foregoing, the sulfonic acid or sulfonate electrolyte additive is present in an electrolyte at a concentration of about 3 weight percent (wt %).

In some examples, including any of the foregoing, the sulfonic acid or sulfonate electrolyte additive is present in an electrolyte at a concentration of about 2 weight percent (wt %).

In some examples, including any of the foregoing, the sulfonic acid or sulfonate electrolyte additive is present in an electrolyte at a concentration of about 1 weight percent (wt %).

In some examples, including any of the foregoing, the sulfonic acid or sulfonate electrolyte additive is present in an electrolyte at a concentration of about 0.5 weight percent (wt %).

In some examples, including any of the foregoing, sulfonic acid or sulfonate the electrolyte additive is present in an electrolyte at a concentration of about 0.1 weight percent (wt %).

In some examples, including any of the foregoing, the sulfonic acid or sulfonate electrolyte additive is present in an electrolyte at a concentration of about 0.05 weight percent (wt %).

In some examples, including any of the foregoing, the sulfonic acid or sulfonate electrolyte additive is present in an electrolyte at a concentration of about 0.01 weight percent (wt %).

In some examples, including any of the foregoing, the sulfonic acid or sulfonate electrolyte additive is present in an electrolyte at a concentration equal to, or greater than, 0.005 weight percent (wt %) to less than, or equal to, 25 wt %.

In some examples, including any of the foregoing, set forth herein is a zinc-battery comprising an electrolyte additive as set forth herein.

In some examples, the zinc-battery comprises an additive as set forth herein and further comprises ZnBr₂. In one embodiment, the ZnBr₂ is at a concentration between about 1 M and 10 M. In one embodiment, the concentration of ZnBr₂ is about 1 M, 2 M, or 3 M. In one embodiment, the concentration of ZnBr₂ is about 2 M.

In some examples, the zinc-battery comprises an additive as set forth herein and further comprises ZnO. In one embodiment, the ZnO is at a concentration between about 0.1 M and 1 M. In one embodiment, the concentration of ZnO is about 0.1 M.

### III. PROCESS FOR MAKING

In some examples, set forth herein is a process for making a zinc battery, comprising contacting an electrolyte set forth herein with a zinc-battery electrode.

In some examples, including any of the foregoing, the zinc-battery comprises a positive electrode.

In some examples, including any of the foregoing, the zinc-battery comprises a negative electrode.

In some examples, including any of the foregoing, the negative electrode is selected from zinc foil, zinc powder, porous zinc, electroplated zinc, zinc alloy, or a combination thereof. In certain examples, the negative electrode is zinc foil. In certain examples, the negative electrode is zinc powder. In certain examples, the negative electrode is porous zinc. In certain other examples, the negative electrode is electroplated zinc. In certain examples, the negative electrode is zinc alloy. In certain examples, the negative electrode is a combination thereof zinc foil, zinc powder, porous zinc, electroplated zinc, and zinc alloy.

### IV. METHODS FOR USING

In some examples, set forth herein is a method of using a zinc battery, comprising electrochemically cycling a zinc-battery comprising an electrolyte set forth herein.

In some examples, set forth herein is a method of using a zinc battery, comprising charging a zinc-battery comprising an electrolyte set forth herein to at least −0.75 V (relative to Ag/AgCl).

In some examples, set forth herein is a method of using a zinc battery, comprising charging a zinc-battery comprising an electrolyte set forth herein to at least −1 V (relative to Ag/AgCl).

In some examples, set forth herein is a method of using a zinc battery, comprising charging a zinc-battery comprising an electrolyte set forth herein to at least −1.2 V (relative to Ag/AgCl).

In some examples, set forth herein is a method of using a zinc battery, comprising charging a zinc-battery comprising an electrolyte set forth herein to at least −1.6 V (relative to Hg/HgO).

In some examples, including any of the foregoing, the charge current density is less than 10 mA/cm².

In some examples, including any of the foregoing, the charge current density is less than 5 mA/cm².

In some examples, including any of the foregoing, the charge current density is less than 2 mA/cm².

In some examples, including any of the foregoing, the charge current density is at least 0.5 mA/cm².

In some examples, including any of the foregoing, the charge current density is at least 1 mA/cm².

In some examples, including any of the foregoing, the charge current density is at least 50 mA/cm².

In some examples, including any of the foregoing, the charge current density is at least 100 mA/cm².

In some examples, including any of the foregoing, the maximum charge current density is less than 200 mA/cm².

In some examples, including any of the foregoing, the method comprises discharging the zinc-battery.

In some examples, including any of the foregoing, the discharge current density is less than 10 mA/cm².

In some examples, including any of the foregoing, the discharge current density is less than 5 mA/cm².

In some examples, including any of the foregoing, the discharge current density is less than 2 mA/cm².

In some examples, including any of the foregoing, the discharge current density is at least 0.5 mA/cm².

In some examples, including any of the foregoing, the discharge current density is at least 1 mA/cm².

In some examples, including any of the foregoing, the discharge current density is at least 50 mA/cm².

In some examples, including any of the foregoing, the discharge current density is at least 100 mA/cm².

In some examples, including any of the foregoing, the maximum discharge current density is less than 200 mA/cm².

In some examples, including any of the foregoing, the method comprises storing the zinc-battery for at least 1 day.

In some examples, including any of the foregoing, the method comprises discharging the zinc-battery.

In some examples, including any of the foregoing, the zinc-battery demonstrates a Coulombic Efficiency greater than 95% for a charge-discharge cycle.

### V. EXAMPLES

Chemicals were commercially purchased unless stated explicitly otherwise.

Electrochemical cycling was performed on a Princeton Applied Research VersaStat 3 potentiostat.

Electrochemical cells were constructed having a negative electrode of either zinc wire or glassy carbon, an aqueous electrolyte, and a platinum counter electrode. Voltages were measured relative to a Ag/AgCl electrode or a Hg/HgO electrode. Unless specified otherwise, the electrolyte included 2 molar (M) ZnBr₂, 0.5 M KCl, and water. Electrolytes were sparged to remove interfering dissolved gasses by bubbling pure nitrogen gas through them while stirring for 30 minutes to 45 minutes prior to each test.

### Example 1—Effect of Sulfonic Acid or Sulfonate Additives on Zinc Dendrite Length

The effect of four additives—sodium isethionate, 3-(benzyldimethylammonio)propanesulfonate, trimethylammonium propane sulfonate, and 2-aminoethane-1-sulfonic acid—on zinc dendrite growth were tested and compared to methanesulfonic acid (MSA). MSA is a known additive for acidic zinc plating. The results are shown in Table 1.

In Table 1, the following legend applies:

0=dendrite growth length of equal to, or greater than, 0.8 mm;

1=dendrite growth length of equal to, or greater than, 0.4 mm to less than 0.8 mm; and

2=dendrite growth of less than 0.4 mm.

To determine the zinc dendrite growth in the presence of each additive, zinc metal was plated onto a circularly shaped glassy carbon electrode, 3 mm in diameter, from a solution of 2M ZnBr₂, 0.5M KCl, and the additive (at 1 weight percent [wt %]) at a potential of −1.2 V relative to Ag/AgCl for 15 minutes. The control sample was plated the same, but without additive.

When sodium isethionate was present in the solution at 1 wt %, zinc metal was plated (electrochemically deposited) with shorter and thinner dendrites as compared to zinc plated from a solution containing 1 wt % MSA. As shown in Table 1, when sodium isethionate was used as the additive, dendrites growth was ranked as a 1, while dendrite growth was ranked as a 0 when MSA was used as the additive. Sodium isethionate differs from MSA in that sodium isethionate has an ethylene instead of a methylene group bonded to the sulfonate and also sodium isethionate has a terminal hydroxyl group. The results here unexpectedly demonstrate that sodium isethionate is a better performing plating additive as compared to MSA.

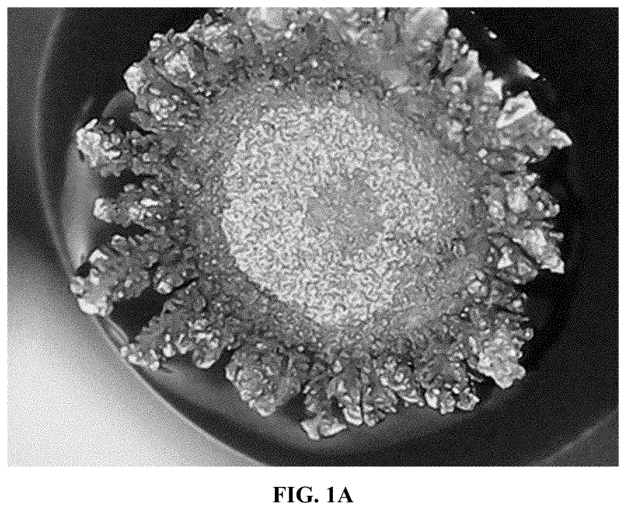

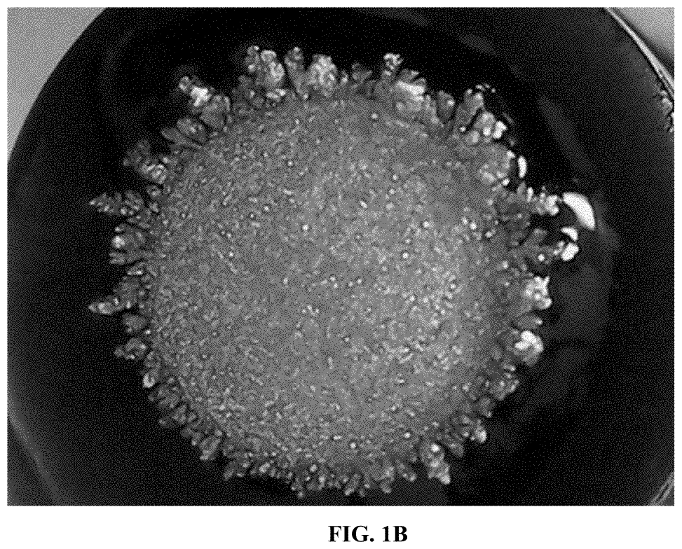

FIG. 1A is an image of zinc plating when 1 wt % of methanesulfonic acid (MSA) is used as an additive and FIG. 1B is an image of zinc plating when 1 wt % of sodium isethionate is used as an additive.

3-(Benzyldimethylammonio) propanesulfonate as an additive (1 wt %) also unexpectedly outperformed MSA with regard to dendrites formation. When plated with MSA, dendrites growth was ranked a 0. However, when using 3-(benzyldimethylammonio)propanesulfonate, dendrites growth was ranked as a 2 as shown in Table 1.

Dendrite growth was ranked as a 1 when trimethylammonium propane sulfonate was used as the additive, and as a 2 when 2-aminoethane-1-sulfonic acid was used as an additive.

TABLE 1
QUALITY OF ZINC PLATING IN THE PRESENCE OF ADDITIVES

| | Dendrite formation |
|---|---|
| | 0 = 0.8 mm or greater |
| | than 0.8 mm; |
| | 1 = 0.4 mm to 0.8 mm; |
| Name | 2 = less than 0.4 mm |
| Control | 0 |
| 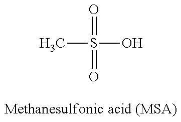 | 0 |
| 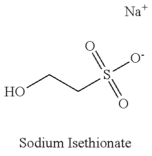 | 1 |
| 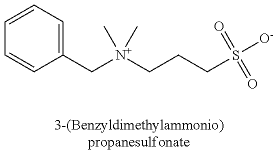 [SMILES: C[N+](C)(CCCS(=O)(=O)[O-])Cc1ccccc1] | 2 |
| 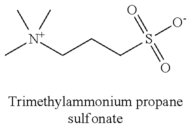 | 1 |
| 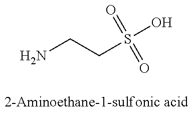 | 2 |

### Example 2—Bromine and pH Stability of Additives—Prophetic Example

Bromine and pH stability are tested by exposing each additive to elemental bromine (Br₂) in the battery electrolyte, which includes 2 molar (M) ZnBr₂, 0.5 M KCl, and water. Individually, 0.10 g of each additive are added to a glass vial with a plastic cap and then 9.90 g of a 2M solution of zinc bromide (ZnBr₂) in water is added, fully dissolving the additive into a clear colorless solution. One vial is kept free of additive to serve as a control. The pH is measured for each vial prior to the addition of 50 microliters of liquid elemental bromine, Br₂. Each vial is shaken briefly to stir and homogenize each sample. The pH is measured again after the addition of bromine, and color and appearance are noted. Then, vials are either stored at room temperature or at 60° C. for periods of days. During storage, their pH periodically is measured and is compared to the control kept in the same condition for the same amount of time. Validation of good stability is determined by pH changes similar to or less than that of the control, as well as the persistence of the yellow/orange color of elemental bromine, Br₂.

### Example 3—Stability of Additives—Prophetic Example

While using elevated temperature can serve as a predictor for longer term stability at lower temperatures, a similar type of test can be done to validate long term stability at more realistic operating conditions. Samples of electrolyte containing additive can be mixed with bromine, sealed, and allowed to sit at room temperature for months or years while their pH and color are periodically measured. Additives that exhibit pH near to or higher than a control sample (as an example: a battery electrolyte of 2 molar (M) ZnBr₂, 0.5 M KCl, and water or water alone) are attractive for use in batteries.

### Example 4—the Effect of Additional Sulfonic Acid or Sulfonate Additives on Zinc Dendrite Length

Electrochemical cells were constructed having a negative electrode of glassy carbon, an aqueous electrolyte, and a platinum counter electrode. These were held at a potential of −1.2 V relative to a Ag/AgCl electrode for 15 minutes. Unless specified otherwise, the electrolyte included 2 molar (M) ZnBr, 0.5 M KCl, water, and the additive. The concentration of the additive is listed in Table 2. Electrolytes were sparged to remove interfering dissolved gasses by bubbling pure nitrogen gas through them while stirring for 30 minutes to 45 minutes prior to each test. The effect on dendrite growth of a variety of representative additives at varying concentrations is provided in Table 2. The control is an electrolyte without additive.

In Table 2:

0=dendrite lengths equal to, or greater than, 0.8 mm;

1=dendrite lengths equal to, or greater than, 0.4 mm to less than 0.8 mm;

2=dendrite lengths less than 0.4 mm.

TABLE 2
QUALITY OF ZINC PLATING IN THE PRESENCE OF ADDITIVES

| | | Additive | Dendrite |
|---|---|---|---|
| Additive | Electrolyte | Concentration | Formation |
| None | 2M ZnBr₂ | N/A | 0 |
| 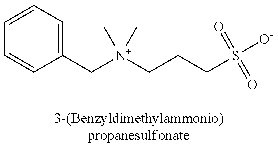 [SMILES: C[N+](C)(CCCS(=O)(=O)[O-])Cc1ccccc1] | 2M ZnBr₂ | 0.1 wt % 1 wt % 10 wt % | — 2 2 |
| 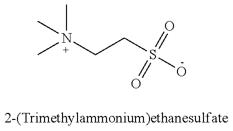 | 2M ZnBr₂ | 0.1 wt % 10 wt % | 1 1 |
| 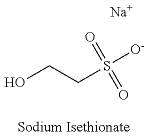 | 2M ZnBr₂ | 0.1 wt % | 1 |
| 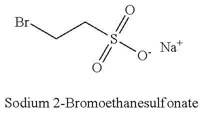 | 2M ZnBr₂ | 1 wt % | 2 |
| 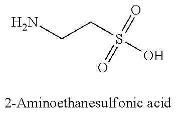 | 2M ZnBr₂ | 1 wt % | — |
| 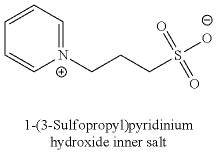 [SMILES: O=S(=O)([O-])CCC[n+]1ccccc1] | 2M ZnBr₂ | 10 wt % 35 wt % | 2 2 |
| 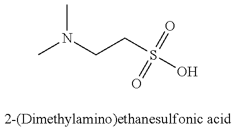 | 2M ZnBr₂ | 25 wt % | 2 |
| 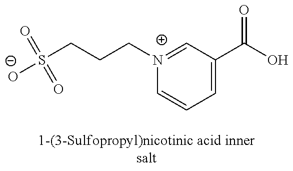 [SMILES: O=C(O)c1ccc[n+](CCCS(=O)(=O)[O-])c1] | 2M ZnBr₂ | 1 wt % | 2 |
| 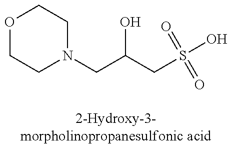 [SMILES: O=S(=O)(O)CC(O)CN1CCOCC1] | 2M ZnBr₂ | 1 wt % | 2 |
| 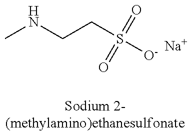 | 2M ZnBr₂ | 1 wt % | 2 |
| 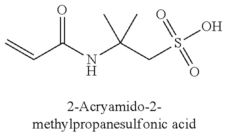 | 2M ZnBr₂ | 1 wt % | — |
| 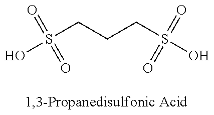 [SMILES: O=S(=O)(O)CCCS(=O)(=O)O] | 2M ZnBr₂ | 1 wt % | 2 |
| 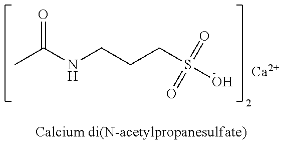 | 2M ZnBr₂ | 1 wt % | — |
| 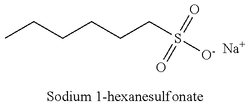 | 2M ZnBr₂ | 1 wt % | 1 |

An optical image was taken of the electroplated zinc on the tip of a glassy carbon electrode that is 3 mm in diameter for certain additives in Table 2 and the control. In each of these images, the zinc was electroplated at the negative electrode at −1.2 V (relative to an Ag/AgCl reference electrode) for 900 seconds.

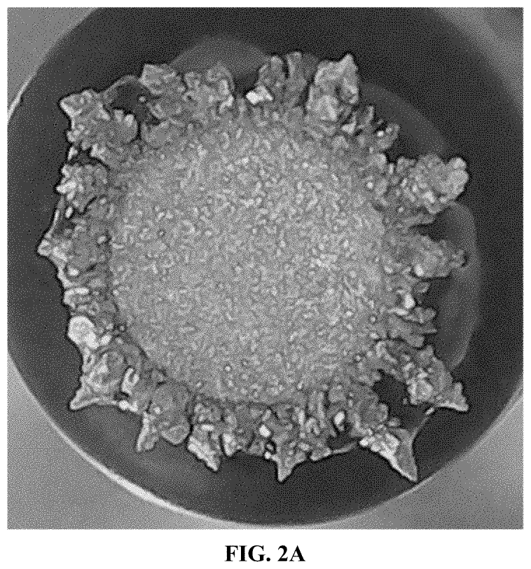

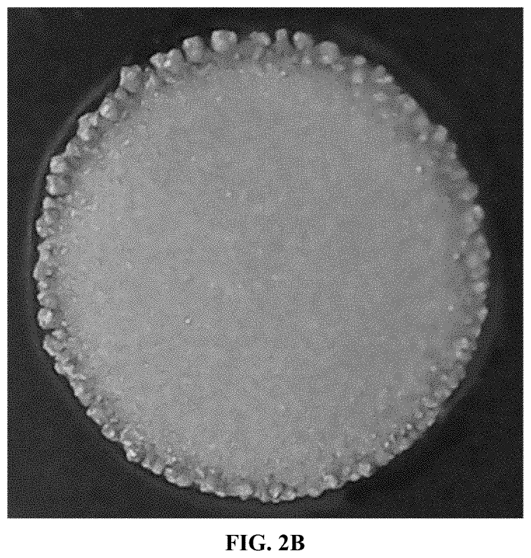

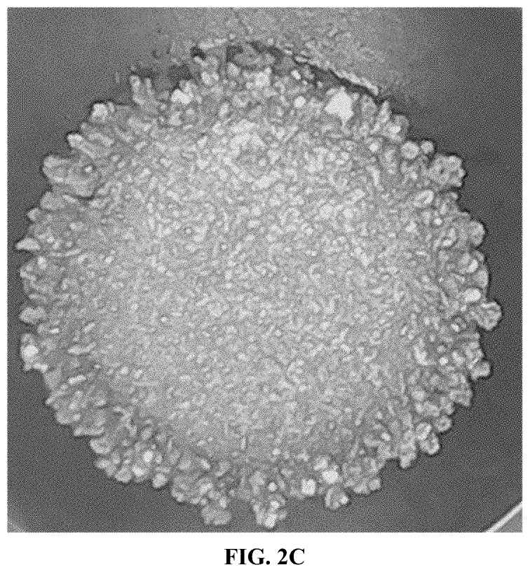

The control is shown in FIG. 2A. As shown in FIG. 2A, zinc dendrite formation was visible, and dendrites grew to an average length of approximately 0.8 mm to 1.5 mm. This demonstrates that without an additive, large dendrite growth is observed in acidic electrolytes, which is problematic for proper battery performance and longevity.

FIG. 2B is an image of the zinc plating when 3-(benzyldimethylammonio)propanesulfonate was used as an additive. As shown in FIG. 2B, zinc dendrite formation is dramatically less than that of FIG. 2A. The average dendrite length was observed as a 76% reduction as compared to the control. The largest dendrites grown measured as an 87% reduction as compared to the control.

FIG. 2C is an image of the zinc plating when 2-(dimethylamino)ethanesulfonic acid was used as an additive. As shown in FIG. 2C, zinc dendrite formation is also notably less than that of FIG. 2A. The average dendrite length was observed as a 60% reduction as compared to the control, and the largest dendrites grown measured as a 75% reduction as compared to the control.

The average dendrite growth for sodium 1-hexane sulfate was observed as a 32% reduction as compared to the control. The largest dendrites grown was observed as a 50% reduction as compared to the control.

### Example 5—the Effect of Additional Sulfonic Acid or Sulfonate Additives on Zinc Dendrite Length Relative to Hg/HgO Electrode

Electrochemical cells were constructed having a glassy carbon negative electrode, an aqueous electrolyte, and a platinum counter electrode. Voltages were measured relative to a Hg/HgO electrode. Unless specified otherwise, the electrolyte included 5.5 molar (M) KOH, 0.1M ZnO and water. Electrolytes were sparged to remove interfering dissolved gasses by bubbling pure nitrogen gas through them while stirring for 30 minutes to 45 minutes prior to each test. Additional salt concentrations were tested. The effect on dendrite growth of representative additives at a concentrations of 1.0 wt % is provided in Table 3. The control is an electrolyte without additive.

In Table 3:

0=dendrite lengths equal to, or greater than, 0.2 mm;

1=dendrite lengths equal to, or greater than, 0.1 mm to less than 0.2 mm;

2=dendrite lengths less than 0.1 mm.

TABLE 3
Quality of zinc plating in the presence of additives

| | | | Charge voltage - |
|---|---|---|---|
| | | | 1.6 V for 900 |
| | | Additive | seconds (vs. |
| Additive | Electrolyte | Concentration | Hg/HgO) |
| None | 5.5M KOH | N/A | 0 |
| 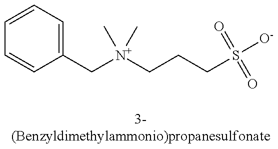 [SMILES: C[N+](C)(CCCS(=O)(=O)[O-])Cc1ccccc1] | 5.5M KOH | 1 wt % | 2 |
| 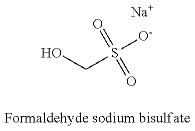 | 5.5M KOH | 1 wt % | 2 |
| 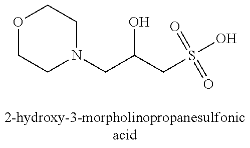 [SMILES: O=S(=O)(O)CC(O)CN1CCOCC1] | 5.5M KOH | 1 wt % | 1 |

When no additive was used, zinc dendrite formation was visible, and many dendrites had grown to lengths of 0.2 mm or greater. In contrast, when an additive was used, less zinc dendrite formation was visible. For example, when 2-hydroxy-3-morpholinopropanesulfonic acid was used as an additive, the average dendrite length was observed as a 43% reduction as compared to the control.

### Example 6—the Effect of Various Additive Concentrations on Zinc Dendrite Length

Electrochemical cells and additive solutions were prepared as described in Example 4 for three additives, 2-(dimethylamino)ethanesulfonic acid, 3-(benzyldimethylammonio) propanesulfonate, sodium isethionate, and 3-(1-pyridinio)-1-propanesulfonate compared to the control (no additive present). The results are provided in Table 4.

TABLE 4
Effect of Concentration of Additive on Dendrite Length

| conc. (wt %) | Ave Dendrite size (mm) |
|---|---|
| 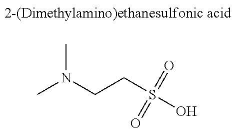 | |
| 0.1 | 0.47 |
| 1 | 0.25 |
| 5 | 0.15 |
| 10 | 0.23 |
| 25 | 0.3 |
| 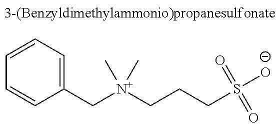 [SMILES: C[N+](C)(CCCS(=O)(=O)[O-])Cc1ccccc1] | |
| 0.1 | 0.38 |
| 1 | 0.17 |
| 5 | 0.1 |
| 10 | 0.05 |
| 25 | 0.05 |
| 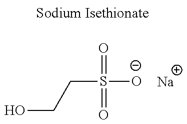 | |
| 0.1 | 0.31 |
| 1 | 0.31 |
| 10 | 0.38 |
| 25 | 0.49 |
| 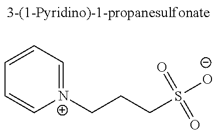 [SMILES: O=S(=O)([O-])CCC[n+]1ccccc1] | |
| 0.1 | 0.6 |
| 5 | 0.38 |
| 10 | 0.29 |
| 35 | 0.15 |

Control (no additive present)

| | |
|---|---|
| N/A | 0.75 |

As shown in Table 4, all four additives are better than the control. However, each exhibits different activity based on the concentration. For example, 3-(benzyldimethylammonio) propanesulfonate and 3-(1-pyridinio)-1-propane sulfonate exhibit a better performance as the concentration increases, while sodium isethionate performs best as the concentration decreases. 2-(Dimethylamino)ethanesulfonic acid shows best results in an intermediate range.

Further, 2-(dimethylamino)ethanesulfonic acid and 3-(benzyldimethylammonio) propanesulfonate are better than sodium isethionate at 1-25 wt 00, and both are good additives at 1-10 wt 0%. As mentioned above, 3-(benzyldimethylammonio) propane sulfonate and 3-(1-pyridinio)-1-propane sulfonate are best at the highest concentrations tested (10-25 wt 0% and 35 wt % for 3-(benzyldimethylammonio) propanesulfonate and 3-(1-pyridinio)-1-propanesulfonate, respectfully.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. An aqueous electrolyte composition comprising an electrolyte additive of Formula A, or a salt, zwitterion, cation, or anion thereof: 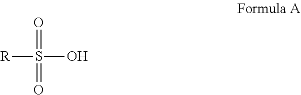
wherein:
R is L-R¹, L-Y⁺, C₃-C₈cycloalkyl, C₃-C₈heteroarylalkyl, or C₃-C₈heterocycloalkyl;
L is a linear C₁-C₆alkylene, branched C₁-C₆alkylene, C₃-C₈cycloalkylene, or C₃-C₈heterocycloalkylene;
wherein L is optionally substituted with one to four —OH;
R¹ is selected from —OH, C₁₋₄alkoxy, —C(O)OR², —NR²C(O)R³, —NR^{4a}R^{4b}, C₁-C₆alkyl, hydroxyC₁-C₄alkyl, halogen, —S(O)R⁵, —S(O)₂R⁵, C₃-C₈cycloalkyl, and C₃-C₈heterocycloalkyl;
R² and R³ are independently selected from hydrogen, C₁-C₆alkyl, C₂-C₆alkenyl, aryl, heteroaryl, and arylC₁-C₄alkyl;
wherein R² and R³ with the exception of hydrogen are independently optionally substituted with one to four R⁶;
R^{4a} and R^{4b} are independently, in each instance, selected from hydrogen, C₁-C₆alkyl, hydroxyC₁-C₄alkyl, —CR⁷R⁸R⁹, —CH₂C(O)R¹⁰, cycloalkyl, aryl, heteroaryl, and arylC₁-C₄alkyl; or
R^{4a} and R^{4b} are taken together with the nitrogen to which they are attached form a 6-membered heterocycloalkyl or heteroaryl optionally substituted with one to four R⁶;
R⁵ is —OH, C₁₋₄alkyl, aryl, or heteroaryl;
R⁶, when present, is independently, in each instance, selected from C₁-C₆alkyl, —NH₂, halogen, —OH, hydroxyC₁-C₄alkyl, and —C(O)OR¹;
R⁷, R⁸, and R⁹ are independently, in each instance, selected from hydrogen, C₁-C₆alkyl, aryl, arylC₁-C₄alkyl, cycloalkyl, —CH₂C(O)R¹⁰, and hydroxyC₁-C₄alkyl;
R¹⁰ is selected from —NH₂, —OH, and C₁-C₄alkyl;
R¹¹ is selected from hydrogen and C₁-C₄alkyl;
Y⁺ is selected from —N⁺R¹²R¹³R¹⁴, C₃-C₈heteroaryl containing at least one quaternary nitrogen, and C₃-C₈heterocycloalkyl containing at least one quaternary nitrogen; and
R¹², R¹³, and R¹⁴ are independently selected from hydrogen, C₁-C₆alkyl, aryl, arylC₁-C₄alkyl, cycloalkyl, hydroxyC₁-C₄alkyl, and —CR⁷R⁸R⁹;
or R¹² and R¹³ are taken together with the nitrogen to which they are attached to form a 6-membered heterocycloalkyl or 6-membered heteroaryl optionally substituted with one to four R⁶;
wherein the composition further comprises an ion selected from the group consisting of Na⁺, K⁺, Ca²⁺, Zn²⁺, a quaternary ammonium cation, and combinations thereof, and
wherein the electrolyte additive is present in the aqueous electrolyte at a concentration equal to, or greater than, 0.005 weight percent (wt %) to less than, or equal to, 50 wt %.

2. The aqueous electrolyte composition of claim 1, wherein the electrolyte additive of Formula A is a compound of Formula I:

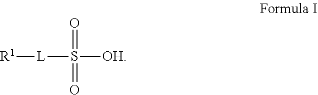

3. The aqueous electrolyte composition of claim 1, wherein the electrolyte additive of Formula A is a compound of Formula IV: 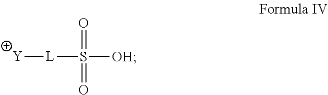
and wherein the electrolyte composition optionally further comprises one or more anions selected from Cl⁻, Br⁻, I⁻, ClO₄⁻, C₂HO₄⁻, HSO₄⁻, HCO₂⁻, ClCH₂CO₂⁻, Cl₃CCO₂⁻, HOCH₂CO₂⁻, CF₃CO₂⁻, H₂PO₄⁻, CH₃SO₃⁻, PhSO₃⁻, p-CH₃-Ph-SO₃⁻, 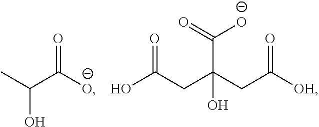
and combinations thereof.

4. The aqueous electrolyte composition of claim 2, wherein the electrolyte additive of Formula I is a compound of Formula II: 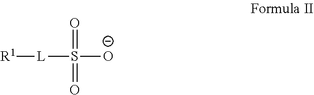
and optionally further comprises at least one cation selected from the group consisting of Na⁺, K⁺, Ca²⁺, Zn²⁺, a quaternary ammonium cation, and combinations thereof.

5. The aqueous electrolyte composition of claim 4, wherein the electrolyte additive of Formula I is a compound of Formula IIb or IIc:

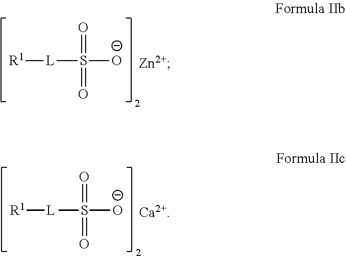

6. The aqueous electrolyte composition of claim 4, wherein the electrolyte additive of Formula II comprises a cation selected from the group consisting of Na⁺, K⁺, Ca²⁺, Zn²⁺, and a quaternary ammonium cation.

7. The aqueous electrolyte composition of claim 4, wherein the electrolyte additive has the following structure:

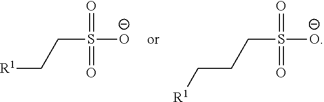

8. The aqueous electrolyte composition of claim 1, wherein R¹ is selected from —OH and —C(O)OR² and R² is selected from hydrogen, methyl, ethyl, n-propyl, isopropyl, n-butyl, isobutyl, and tert-butyl.

9. The aqueous electrolyte composition of claim 8, wherein R¹ is —OH.

10. (canceled)

11. (canceled)

12. The aqueous electrolyte composition of claim 3, wherein the compound of Formula IV is a compound of Formula III:

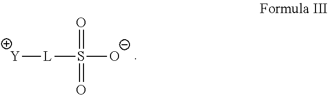

13. The aqueous electrolyte composition of claim 12, wherein the electrolyte additive has the following structure:

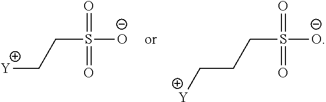

14. The aqueous electrolyte composition of claim 1, wherein Y⁺ is 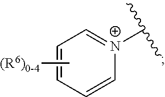
and where 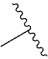
indicates the bond between Y and L.

15-19. (canceled)

20. The aqueous electrolyte composition of claim 1, wherein the compound of Formula A is a compound of Formula V:

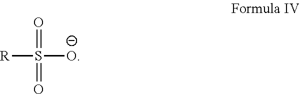

21. (canceled)

22. (canceled)

23. The aqueous electrolyte composition of claim 1, wherein R is

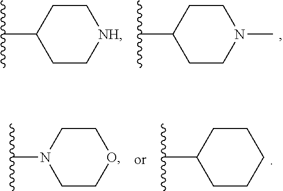

24. The aqueous electrolyte composition of claim 12, wherein the electrolyte additive is selected from

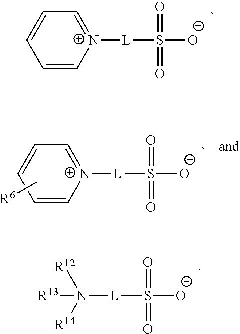

25. The aqueous electrolyte composition of claim 12, wherein the electrolyte additive is selected from

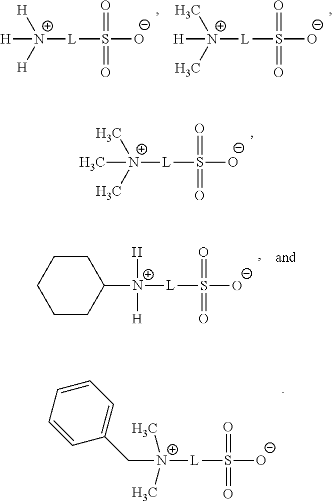

26. The aqueous electrolyte composition of claim 12, wherein the electrolyte additive is selected from

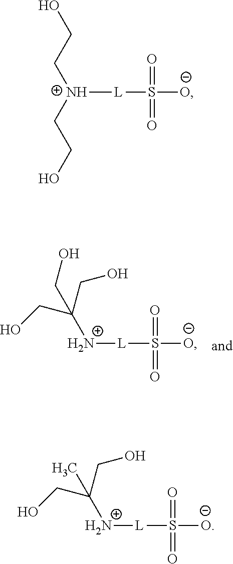

27. The aqueous electrolyte composition of claim 20, wherein the electrolyte additive is selected from

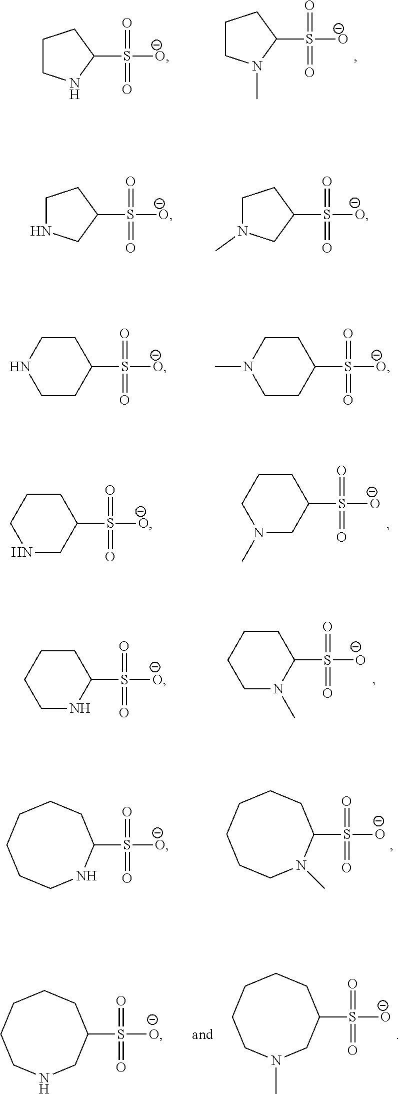

28-30. (canceled)

31. The aqueous electrolyte composition of claim 1, wherein the electrolyte additive is selected from

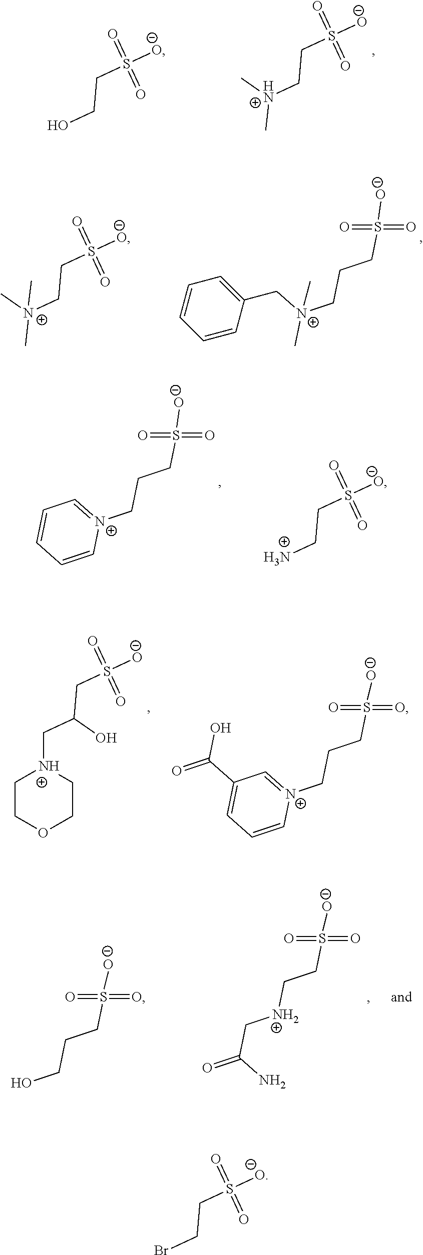

32-58. (canceled)

59. A process for making a zinc battery, comprising
contacting an aqueous electrolyte composition of claim 1 with a zinc-battery electrode.

60-66. (canceled)
